(19) United States
(12) Patent Application Publication
(10) Pub. No.: US 2021/0331276 A1
(43) Pub. Date: Oct. 28, 2021

(54) A ROLLER LASER TEXTURING PROCESSING EQUIPMENT AND ITS PROCESSING METHOD

(71) Applicant: Jiangsu University, Zhenjiang, Jiangsu (CN)

(72) Inventors: Yonghong Fu, Zhenjiang, Jiangsu (CN); Tianyang Chen, Zhenjiang, Jiangsu (CN); Jinghu Ji, Zhenjiang, Jiangsu (CN); Faquan Tang, Zhenjiang, Jiangsu (CN); Hangcheng Zhang, Zhenjiang, Jiangsu (CN); Hao Fu, Zhenjiang, Jiangsu (CN)

(21) Appl. No.: 16/627,423

(22) PCT Filed: Dec. 28, 2018
(86) PCT No.: PCT/CN2018/124564

§ 371 Date: Dec. 30, 2019

(30) Foreign Application Priority Data
Nov. 27, 2018 (CN) 201811469173.2

(51) Int. Cl. B23K 26/352; B23K 26/06; B23K 26/08; B23K 37/053

(52) U.S. Cl. CPC B23K 26/355; B23K 26/0604; B23K 2101/20; B23K 26/3584; B23K 37/0538; B23K 26/0823

(57) ABSTRACT

Provided is a roller laser texturing processing equipment and its processing method, comprising the following steps: dividing the processing area, determining the distribution scheme: obtaining a distribution scheme of end-to-end, unordered and uniform texturing lattice according to said roller processing unit parameters and morphological parameters; determining the output signal: the laser output position signal, beam energy regulation signal and deflection signal of one-dimensional beam deflection unit are obtained through the information processing module; performing roller laser texturing processing: said laser output position signal is used to control the light source module to emit the laser; said beam energy regulation signal and deflection signal of one-dimensional beam deflection unit are input into the laser terminal output module, respectively, to generate an unordered laser lattice, each laser terminal output module is used to process a roller processing unit. The present invention can guarantee the unordered degree of the texturing points and the uniformity of the morphology distribution at the same time, the surface consistency of the produced cold-rolled plate is better in the subsequent coating treatment.

### TECHNICAL FIELD

The invention relates to laser texturing processing technology in the field of surface treatment, in particular to a roller laser texturing processing equipment and its processing method.

### BACKGROUND ART

Certain morphology parameters of the surface of cold rolled plate have an important influence on the stamping property and the surface coating or plating performance of steel sheets, however, the surface morphology of cold rolled plate depends to a large extent on the surface morphology of working rolls of the rolling mill and skin-pass rolling mill sets in cold rolling production process. In essence, the surface morphology of cold rolled plate is an attenuated “copy” of the surface morphology of the roller. In order to make the surface of strip steel achieve the desired surface morphology, the method of roller surface texturing is generally adopted. Different kinds of cold rolled plates have different requirements on the types of texturing morphology and the microscopic size of morphology. The retentivity, consistency and uniformity of texturing morphology have a significant influence on the surface quality consistency of the same batch of cold rolled plates. The unordered degree in the arrangement of the texturing morphology is positively correlated with the surface quality of the cold rolled plate in subsequent coating treatment.

At present, the main methods used for roller texturing are Shot Blast Texturing (SBT), Electrical Discharge Texturing (EDT) and Laser Texturing (LT). SBT depends on hard particles impinging on the surface of roller to form concave texturing morphology. The obvious defects of this technology includes: 1) the formed texturing morphologies are similar, and the microscopic size of texturing morphology is difficult to adjust, so the rolling requirements of different kinds of steel sheets cannot be met; 2) the processing environment is harsh, and it is difficult to be integrated into the cold rolled plate production line. EDT is to generate a pulsed spark discharge between the electrode and the surface of the roller in the insulating liquid. The surface of the roller is etched by the instantaneous high temperature generated by partial discharge to form texturing morphology, and the morphology arrangement is random. The defects of this technology are as follows: 1) the texturing morphology formed by ablating the surface of the roller by thermal effect, has four layers of a recast layer, a re-quenching layer, a heat-affected layer and a substrate, wherein the recast layer which roughens the surface of the roller is liable to peel off, so the morphology has poor retentivity and short life, which seriously affects the surface quality consistency of the same batch of rolled plates; 2) electrode loses in texturing processing, so although there is electrode compensation feedback, it is difficult to ensure that the microscopic size of texturing morphology of the surface of roller is consistent and controllable; 3) due to the consumption of parts such as electrodes during processing, there is a continuous cost in the use of the equipment; 4) the equipment input cost is high.

With regard to laser texturing, the texturing morphology is produced by laser ablation or laser melting on the surface of roller using laser thermal effect. There are many types of texturing morphologies, and it is convenient to adjust the microscopic size of the morphology by changing the laser parameters. But, the following problems still exist: 1) for the texturing morphology processed by laser ablation, the convex part on the surface layer of the morphology is a recast layer, which is liable to peel off in the process of cold rolling, resulting in poor retentivity of morphology; 2) laser operating point (focal point) is fixed during laser processing, so it is difficult to process the texturing morphology of unordered arrangement; 3) when the texturing morphology is randomly distributed, there will always be a lot of overlaps of texturing morphology, and the uniformity of the distribution cannot be guaranteed.

One Chinese patent discloses a laser texturing method for achieving uniform and random distribution of texturing points. Each laser pulse is randomly delayed and deflected by random signals, and sparse texturing morphology distribution is processed on the surface of roller, and then the efficiency and area occupancy are increased through multiple laser heads and multiple passes. Although the problem of orderliness of laser texturing is solved, the random delay and random deflection of laser pulse and multi-pass processing method will lead to a lot of overlaps of texturing morphology, resulting in poor uniformity of morphology distribution, which directly affects the subsequent coating performance. At the same time, repeatedly overlapping regions of the morphology are subjected to laser action for a plurality of times, which is equivalent to tempering the local area of the roller, affecting or even destroying the metallographic structure of the surface layer of the roller, and greatly reducing the service life of the roller.

One Chinese patent discloses a laser processing system and its method for surface texturing of rollers, which irregularly deflects the texturing points. The pseudo-random signals, which are obtained by the accurate control of sinusoidal wave, are used to control the pseudo-random deflection device to randomly deflect the laser emitted to the surface of the roller workpiece every time, so as to realize the irregular distribution of the texturing points. In the distribution with large area occupancy, the problem of distribution uniformity still exists in the scheme, and for the morphology, there will be piles and overlaps, resulting in a poor uniformity of distribution.

One Chinese patent discloses a laser texturing processing device which can control the deflection and swing of the focused light spot, wherein a piezoelectric ceramic deflection system is arranged before laser focus to make the focused light spot swing in two dimensions, so as to process the irregularly distributed texturing points. The patent does not disclose the method to control the uniformity of morphology distribution, and the problem of uniformity has not been solved.

### The Content of Invention

Directed to the deficiencies in the prior art, a roller laser texturing processing equipment and its processing method are provided in the present invention. In the area to be processed on the surface of the roller, appropriate texture morphology is selected and matched with specific output laser parameters. Each processing unit is processed synchronously through one of a plurality of laser terminal output modules, and a scheme of end-to-end, unordered and uniformly distributed lattice is designed to detect the consistency of the instantaneous position signal of the coaxial encoder and the laser output position signal. When the laser terminal output module is in a determined position, a laser with determined parameters is emitted. Meanwhile, different signals are sent to beam energy regulating unit of each laser terminal output module, so as to complete energy attenuation adjustment, and the same signal is sent to one-dimensional beam deflection unit of each laser terminal output module to complete one-dimensional deflection of beam, so that the laser focus of each laser terminal output module processes the texturing hard points in turn by using different laser energy according to the designed scheme of end-to-end, unordered and uniformly distributed lattice.

The present invention achieves the above technical objects by the following technical means.

A roller laser texturing processing method, characterized in that, it comprises the following steps:

Dividing processing zones: the processing zone on the surface of roller is evenly divided into several roller processing units;

Determining the scheme of distribution: according to the mentioned roller processing unit parameters and morphological parameters, the distribution scheme of end-to-end, unordered and uniformly distributed texturing lattice is obtained by the design method of end-to-end, unordered and uniformly distributed lattice;

Determining the output signal: on the basis of the mentioned distribution scheme of end-to-end, unordered and uniformly distributed texturing lattice, the machine tool parameters and laser parameters, the laser output position signal, beam energy regulation signal and deflection signal of one-dimensional beam deflection unit are obtained through the information processing module;

Laser texturing processing of roller: said laser output position signal is used for controlling the light source module to emit laser; said beam energy regulation signal and deflection signal of one-dimensional beam deflection unit are input into the laser terminal output module, respectively, to generate the unordered laser lattice, each laser terminal output module is used for processing one roller processing unit.

Furthermore, specifically, division of the processing zone includes:

Determining the roller surface processing zone; said roller processing zone being a square area with length L₀₁ and width πd, wherein, L₀₁=5%-100%Lo, L₀₋₀₁ is the distance from the end face of roller, L₀₋₀₁=90%L₀ ; L₀ is the developed length of the roller surface, and d is the diameter of the roller;

The processing zone of roller is evenly divided into m roller processing units, and the length of any roller processing unit is L₁,

$${L}_{1} = \frac{1}{{m}_{max}} {L}_{01} ;$$

the width or any roller processing unit is πd; wherein, m ∈ {1,2,3. . . mₘₐₓ}, mₘₐₓ=1−30.

Furthermore, the laser terminal output module includes beam back-turning unit, beam energy regulation unit and one-dimensional beam deflection unit; the incident laser from said light source module passes successively through the beam back-turning unit, beam energy regulation unit and one-dimensional beam deflection unit, and then into the roller processing unit;

Said beam back-turning unit is used to split the incident laser from the light source module into a reflected laser perpendicular to the axis direction of the roller and a transmitted laser parallel to the axis direction of the roller; said reflected laser enters into the beam energy regulating unit, and said transmitted laser enters into the next laser terminal output module;

Said beam energy regulating unit is used to change the energy of said reflected laser;

Said one-dimensional beam deflection unit is used to offset the angle of said reflected laser.

Furthermore, based on the different coating properties of each semi-reflective lens, the beam back-turning unit makes the energy ratio of reflected laser and transmitted laser as:

$$\frac{{P}_{m}}{{P}_{m -}} = 1 : ( {m}_{max} - m ) ; {P}_{m} = {P}_{output} = \frac{1}{{m}_{max}} {P}_{i n p u t} , m = 1 , 2 , 3 . . . {m}_{max} ;$$

where Pₘ is the power of reflected laser split by the beam back-turning unit in the Lineₘ-th laser terminal output module;

Pₘ—is the power of transmitted laser split by the beam back-turning unit in the Lineₘ-th laser terminal output module;

Pᵢₙₚᵤₜ is the power of laser source output by the laser source module;

Pₒᵤₜₚᵤₜ is the laser power input by the laser terminal output module.

Said beam energy regulating unit attenuates the beam energy at a fixed value based on the input electrical signal ψ, that is P_{focus} =(1-Damp(ψ) P)ₒᵤₜₚᵤₜ, wherein, is the input electric signal of the driving power supply of the beam energy regulating unit, ψ ∈ [ψₘᵢₙ, ψₘₐₓ], the corresponding energy attenuation ratio Damp(ψ) varies from 0 to 100%, ψₘᵢₙ is the minimum input electrical signal; ψₘₐₓ is the maximum input electrical signal; Damp (ψ) is the laser energy attenuation ratio; P_{focus} is the laser power output by said beam energy regulating unit;

Said one-dimensional beam deflection unit makes the beam deflect in one-dimension at a fixed angle α according to the input electrical signal ξ, then the beam passes through the focus lens and acts on the area to be processed, so as to make focal point offset a determined distance σ relative to the optical axis,

σ=f(α,L₂, f)=f(α(ξ),L₂,f),

σₘᵢₙ=f(αₘᵢₙ, L₂, f)=f(0L₂, f)

σₘₐₓ=f(η*αₘₐₓ, L₂, f)

wherein, L₂ is the distance between said one-dimensional beam deflection unit and the surface of the workpiece; f is the focal length when said one-dimensional beam deflection unit does not deflect; α is the deflection angle of beam caused by the one-dimensional beam deflecting unit, that is α=α(ξ); αₘᵢₙ is the minimum deflection angle of beam caused by the one-dimensional beam deflecting unit; αₘₐₓ is the maximum deflection angle of beam caused by the one-dimensional beam deflecting unit; η is the safety service factor of one-dimensional beam deflection unit; σ is the offset of focal position; σₘᵢₙ is the minimum offset of focal position; σₘₐₓ is the maximum offset of focal position.

Furthermore, said design method of the end-to-end, unordered and uniform lattice distribution includes the following steps:

According to the distribution of morphology parameters, the circle center set A₀ of texturing points of uniform lattice distribution is established, which is as follows specifically:

$${A}_{0} = \{ ( {x}_{0 i} , {y}_{0 j} ) \vert \begin{matrix}{x}_{0 i} = a ( j - 1 ) , {y}_{0 j} = b ( i - 1 ) , \\ i = 1 , 2 , 3 . . . {i}_{max} , j = 1 , 2 , 3 . . . {j}_{max}\end{matrix} \}$$

wherein, A₀ is the set of circle center coordinates of texturing points of uniform lattice distribution; (x₀ᵢ, y₀ᵢ) is the circle center coordinate of texturing point of uniform lattice distribution in row i and column j; i represents the row serial number; iₘₐₓ is the maximum row serial number; iₘₐₓ=πd/b; j represents the column serial number; jₘₐₓ=[L₁/α]+1; j iₘₐₓ is the maximum column serial number; α is the morphologic distribution dot spacing, which is the distance between two texturing hard points in the x direction; b is morphologic distribution line spacing, which is the distance between two texturing hard points in they direction;

The set ΔX of random displacement vectors for each texturing point in uniform lattice distribution is established, which is as follows specifically:

$$Δ X = \{ ( δ {x}_{i} , δ {y}_{j} ) \vert \begin{matrix}δ {x}_{i} = ran d ( - 1 , 1 ) * {ɛ}_{b} , \\ δ {y}_{i} = ran d ( - 1 , 1 ) * {ɛ}_{a} , \\ i = 1 , 2 , 3 . . . {i}_{max} , j = 1 , 2 , 3 . . . {j}_{max}\end{matrix} \}$$

wherein, ΔX is the set of random displacement vectors for each texturing point in uniform lattice distribution; (δxᵢ, δyⱼ) is the random displacement vector of the circle center coordinate(x₀ᵢ, y₀ⱼ) of the texturing points of uniform lattice distribution in row i and column j in the uniform lattice distribution; εₐ is the constant of column offset; ε_{b} is the constant of row offset;

Establishing the circle center set A of texturing points of unordered and uniform distribution: add the set A₀ of circle center coordinates of texturing points of uniform lattice distribution to the set ΔX of random displacement vectors for each texturing point in uniform lattice distribution, as follows:

$$A = {A}_{0} + Δ X = \{ ( {x}_{i} , {y}_{j} ) \vert \begin{matrix}( {x}_{i} , {y}_{j} ) = ( {x}_{0 i} , {y}_{0 j} ) + ( δ {x}_{i} , δ {y}_{j} ) , \\ i = 1 , 2 , 3 . . . {i}_{max} , j = 1 , 2 , 3 . . . {j}_{max}\end{matrix} \}$$

wherein, A is the circle center set of texturing points of unordered and uniform distribution; (xᵢ, yⱼ) is the circle center coordinates of texturing points of unordered and uniform distribution;

Finding the bad points: find the set SP of row and column sequences of the bad points of unordered and uniform distribution according to the tolerance to overlap of texturing points, as follows specifically:

$$SP = \{ ( {u}_{q} , {w}_{q} ) \vert \begin{matrix}( {u}_{q} , {w}_{q} ) = ( i , j ) , \\ \vert A ( i , j ) - A ( i + 1 , j ) \vert < ζ * D or \\ \vert A ( i , j ) - A ( i , j + 1 ) \vert < ζ * D or \\ \vert A ( i , j ) - A ( i + 1 , j + 1 ) \vert < ζ * D , \\ i = 2 , 3 , 4 . . . {i}_{max} - 1 , \\ j = 2 , 3 , 4 . . . {j}_{max} - 1 , \\ q = 1 , 2 , 3 . . . \end{matrix} \}$$

wherein, SP is the set of row and column sequences of the bad points of unordered and uniform distribution; A(i, j) is the circle center coordinate of texturing points in row i and column j in the set of the center coordinates of texturing points of unordered and uniform distribution in row i and column j; (u_{q}, w_{q}) is the coordinate row and column sequences of the q-th bad point; q is the sequence number of bad point; ζ is an overlap tolerance constant of texturing points of unordered and uniform distribution;

Estimating whether there is a bad point: there are bad points when SP≠Ø, then the random displacement vector set ΔX is adjusted according to the bad points set SP of unordered and uniform distribution, and the steps of establishing the circle center set A of texturing points of unordered and uniform distribution and finding the bad points are repeated until SP=Ø; while SP=Ø, there are no bad points;

Establishing the circle center set Aex of texturing points of unordered and uniform distribution by left-right exchange of the circle center set A of texturing points of unordered and uniform distribution with reference to the axial center line: when SP=Ø the circle center set A of texturing points of unordered and uniform distribution is subjected to left-right exchange with reference to the axial center line, so that the lap joint of the processing areas of a number of laser terminal output modules can be achieved:

$$Aex = \{ ( {xex}_{i} , {yex}_{j} ) \vert \begin{matrix}( {xex}_{i} , {yex}_{j} ) = \{ \begin{matrix}( {x}_{i} + \frac{1}{2} {L}_{1} , {y}_{j} ) , {x}_{i} < \frac{1}{2} {L}_{1} \\ ( {x}_{i} - \frac{1}{2} {L}_{1} , {y}_{j} ) , {x}_{i} \geq \frac{1}{2} {L}_{1}\end{matrix} , \\ ( {x}_{i} , {y}_{j} ) ∈ A , \\ i = 1 , 2 , 3 . . . {i}_{max} , j = 1 , 2 , 3 . . . {j}_{max}\end{matrix} \}$$

wherein, Aex is the circle center set of texturing points of unordered and uniform distribution which is obtained through left-right exchange of the circle center set A of texturing points of unordered and uniform distribution with reference to the axial center line; (xexᵢ, yexⱼ) refers to the circle center coordinates of texturing points in row i and column j after left-right exchange;

Finding the bad points in the area near the center line: in the area near the center line after the process of left-right exchange, find the set SPex of row and column sequences of the bad points of unordered and uniform distribution according to the tolerance to overlap of texturing points, as follows specifically:

$$SPex = \{ ( {uex}_{qex} , {wex}_{qex} ) \vert \begin{matrix}( {uex}_{qex} , {wex}_{qex} ) = ( i , j ) , \\ \vert Aex ( i , j ) - Aex ( i + 1 , j ) \vert < ζ * D or \\ \vert Aex ( i , j ) - Aex ( i , j + 1 ) \vert < ζ * D or \\ \vert Aex ( i , j ) - Aex ( i + 1 , j + 1 ) \vert < ζ * D , \\ Aex ( i , j ) ∈ Center , \\ i = 1 , 2 , 3 . . . {i}_{max} , \\ j = 1 , 2 , 3 . . . {j}_{max} , \\ qex = 1 , 2 , 3 . . .\end{matrix} \}$$

wherein, SPex is the set of row and column sequences of the bad points of unordered and uniform distribution found in the area near the center line after the process of left-right exchange according to the tolerance to overlap of texturing points; (uex_{qex}, wex_{qex}) is the row and column sequences of coordinate of the qex-th bad point; qex is the sequence number of bad point; Aex(i, j) is the circle center coordinates of texturing point in row i and column j in the set of the circle center coordinates of texturing points of unordered and uniform distribution after exchange; Center is the area near the center line after the process of left-right exchange:

$$Center = \{ ( x , y ) \vert x ∈ [ ( 1 - \frac{\overline{ω}}{2} ) \frac{{L}_{1}}{2} , ( 1 + \frac{\overline{ω}}{2} ) \frac{{L}_{1}}{2} ] , y ∈ [ 0 , πd ] \}$$

where ω̅ is the proportion of the area near the input center line;

Estimating whether there is a bad point in the area near the center line: there are bad points when SPex≠Ø, then the position of bad points in the area near the centerline is adjusted according to the bad points set SP ex of unordered and uniform distribution in the area near the centerline, and the steps of establishing the circle center set Aex of texturing points of unordered and uniform distribution by left-right exchange of the circle center set A of texturing points of unordered and uniform distribution with reference to the axial center line and finding the bad points in the area near the center line are repeated until SPex=Ø;

While SPex=Ø, there are no bad points, that is, Aex is the mentioned distribution scheme of end-to-end, unordered and uniformly distributed texturing lattice.

Furthermore, the random displacement vector set ΔX is adjusted according to the bad points set SP of unordered and uniform distribution, as follows specifically:

$$Δ X = \{ ( δ {x}_{i} , δ {y}_{j} ) \vert \begin{matrix}( δ {x}_{i} , δ {y}_{j} ) = ( δ x r {e}_{i} , δ {yre}_{j} ) \\ ( {δ xre}_{i} , {δ yre}_{j} ) ∈ Δ Xre , \\ i = 1 , 2 , 3 \text{. . .} {i}_{max} , j = 1 , 2 , 3 . . . {j}_{max} ,\end{matrix} \}$$

$$where Δ Xre = \{ ( δ x r {e}_{i} , δ {yre}_{j} ) \vert \begin{matrix}( δ x r {e}_{i} , δ {yre}_{j} ) = \{ \begin{matrix}λ ( δ {x}_{i} , δ {y}_{j} ) , ( i , j ) ∈ SP \\ ( δ {x}_{i} , δ {y}_{j} ) , ( i , j ) ∉ {SP}^{′}\end{matrix} \\ i = 1 , 2 , 3 . . . {i}_{max} , j = 1 , 2 , 3 . . . {j}_{max} , \\ ( δ {x}_{i} , δ {y}_{j} ) ∈ Δ X\end{matrix} \}$$

wherein, ΔXre is the adjusted set of random displacement vectors; (δxreᵢ, δyreⱼ) is the adjusted random displacement vector; λ is the adjustment ratio of random displacement vector for a bad point;

The position of bad points in the area near the centerline is adjusted according to the mentioned bad points set SPex of unordered and uniform distribution in the area near the centerline, as follows specifically:

$$Aex = \{ ( xe {x}_{i} , ye {x}_{j} ) \vert \begin{matrix}( x e {x}_{i} , ye {x}_{j} ) = ( x r {e}_{i} , {yre}_{j} ) , \\ ( {xre}_{i} , {yre}_{j} ) ∈ Are , \\ i = 1 , 2 , 3 . . . {i}_{max} , j = 1 , 2 , 3 . . . {j}_{max} ,\end{matrix} \}$$

$$where Are = \{ ( x r {e}_{i} , y r {e}_{j} ) ( \vert \begin{matrix}( {xre}_{i} , {yre}_{j} ) = \\ \{ \begin{matrix}( {xex}_{i} , {yex}_{j} ) - ϑ ( δ {x}_{i} , δ {y}_{j} ) , ( i , j ) ∈ SPex \\ ( {xex}_{i} , {yex}_{j} ) , ( i , j ) ∉ SPex\end{matrix} , \\ , \\ i = 1 , 2 , 3 . . . {i}_{max} , j = 1 , 2 , 3 . . . {j}_{max} , \\ ( {xex}_{i} , {yex}_{j} ) ∈ Aex , \\ ( δ {x}_{i} , δ {y}_{i} ) ∈ Δ X\end{matrix} \}$$

wherein, Are is the set of the circle center coordinates of texturing points of unordered and uniform distribution after adjusting the positions of bad points in the area near the centerline; (xreᵢ,yreⱼ) is the circle center coordinate of a texturing point in row i and column j in the set of the circle center coordinates of texturing points of unordered and uniform distribution after adjusting the positions of bad points in the area near the centerline; ϑ is the adjustment ratio of coordinates of bad points in the area near the centerline.

Furthermore, the laser output position signal, beam energy regulation signal and deflection signal of one-dimensional beam deflection unit are obtained through the information processing module, as follows specifically:

Calculating the angle between the motion track of focal point and the axial direction of roller: when the one-dimensional beam deflection unit is not working, that is α=0, the angle θ between the motion track of focal point and the axial direction of roller is:

$$θ = {tan}^{- 1} \frac{π * n * d}{v}$$

where n is rotating speed of the roller; v is the running speed of the laser terminal output module;

Determining the set K of focal point motion track sequence number and calculating the set P of the number of turns of each focal point motion track moving around the metal cylinder,

$$k ∈ K = \{ 1 , 2 , 3 , … {k}_{max} \} , where {k}_{max} = \{ \begin{matrix}\frac{π d}{{σ}_{max} tan θ} , \frac{π d}{{σ}_{max} tan θ} is an integer \\ ⌊ \frac{π d}{{σ}_{max} tan θ} ⌋ + 1 , \frac{π d}{{σ}_{max} tan θ} is not an integer\end{matrix} ; \\ p ∈ P = \{ 1 , 2 , 3 … {p}_{max} \} , where {p}_{max} = \{ \begin{matrix}\frac{{L}_{1}}{π d cot θ} , \frac{{L}_{1}}{π d cot θ} is an integer \\ ⌊ \frac{{L}_{1}}{π d cot θ} ⌋ + 1 , \frac{{L}_{1}}{π d cot θ} is not an integer \end{matrix} ;$$

wherein, K is the set of focal point motion track sequence number; k is the k-th focal point motion track, that is, the k-th processing process; P is the set of the number of turns of each focal point motion track moving around the metal cylinder; p is the p-th turn of focal point motion track moving around the metal cylinder;

When the deflection angle α of the one-dimensional beam deflection unit is α ∈ [0, η* αₘₐₓ], the set Λ of focal point coverage Λₖ of laser terminal output module during the k-th processing process is determined, as follows specifically:

$$Λ = \{ {Λ}_{k} \vert {Λ}_{k} = \{ ( x , y ) \vert \begin{matrix}x ∈ [ {xk}_{min} ( y , p = 1 ) , {xk}_{max} ( y , p = 1 ) ) ⋃ \\ [ {xk}_{min} ( y , p = 2 ) , {xk}_{max} ( y , p = 2 ) ) ⋃ \\ [ {xk}_{min} ( y , p = 3 ) , {xk}_{max} ( y , p = 3 ) ) ⋃ \\ … ⋃ \\ [ {xk}_{min} ( y , p = {p}_{max} ) , {xk}_{max} ( y , p = {p}_{max} ) ) , \\ y ∈ [ 0 , π d )\end{matrix} \} , k = 1 , 2 , 3 … {k}_{max} \} , \\ where$$

$${xk}_{min} ( y , p ) = xk ( y , p , σ = 0 ) = \frac{[ y - \frac{π d}{{k}_{max}} k ]}{tan θ} + \frac{π d}{tan θ} ( p - 1 ) , y ∈ [ 0 , π d ) , p ∈ P , k ∈ K , \\ {xk}_{max} ( y , p ) = xk ( y , p , σ = {σ}_{max} ) = \frac{[ y - \frac{π d}{{k}_{max}} ( k - 1 ) ]}{tan θ} + \frac{π d}{tan θ} ( p - 1 ) , y ∈ [ 0 , π d ) , p ∈ P , k ∈ K ,$$

where Λ is the set of focal point coverage of laser terminal output module during each processing process; Λₖ is the focal point coverage of laser terminal output module during the k-th processing process; xkₘᵢₙ(y, p)=xk(y, p, σ=0) is the equation of the p-th turn of the k-th focal point motion track, when the deflection angle α=0, that is, deflection offset σ=0; xkₘₐₓ(y, p)=xk(y, p, σ=σₘₐₓ) is the equation of the p-th turn of the k-th focal point motion track, when the deflection angle α=η* αₘₐₓ, that is, deflection offset σ=σₘₐₓ;

The set Φ of the circle center coordinates of unordered and uniform texturing points in the focal point coverage of laser terminal output module during each processing process is counted, as follows specifically:

$$Φ = \{ {Φ}_{k} \vert k = 1 , 2 , 3 … {k}_{max} \} , \\ where {Φ}_{k} = \{ ( {x}_{rk} , {y}_{rk} ) \vert \begin{matrix}( {x}_{rk} , {y}_{rk} ) = ( {xex}_{i} , {yex}_{j} ) , \\ ( {xex}_{i} , {yex}_{j} ) {ϵΛ}_{k} , ( {xex}_{i} , {yex}_{j} ) ∈ Aex , \\ i = 1 , 2 , 3 … {i}_{max} , j = 1 , 2 , 3 … {j}_{max} , \\ rk = 1 , 2 , 3 …\end{matrix} \} k ∈ K ,$$

wherein, Φ is the set of the circle center coordinates of unordered and uniform texturing points in the focal point coverage of laser terminal output module during each processing process; Φₖ is the circle center coordinates of unordered and uniform texturing points in the focal point coverage Λₖ of laser terminal output module during the k-th processing process, that is, the circle center coordinates fall into the set of the circle center coordinates of texturing points between the two trajectories xkₘᵢₙ=xk(y, σ=0) and xkₘₐₓ=xk(y, σ=σₘₐₓ); (xᵣₖ, yᵣₖ) is the circle center coordinate of the rk-th unordered and uniform texturing point included during the k-th processing process; rk is the statistical sequence of unordered and uniform texturing points included in the k-th processing process;

Determining the set Ωₖ of circle center coordinates of the texturing points after sorting in the k-th processing process. (xᵣₖ, yᵣₖ) is sorted according to the processing sequence of the texturing points to obtain the set Ωₖ of circle center coordinates of the texturing points after sorting. The specific sorting rules are as follows:

$${Ω}_{k} = \{ ( {x}_{τ k} , {y}_{τ k} ) \vert τ k = 1 , 2 , 3 … {rk}_{max} \} = \{ \begin{matrix}\{ \begin{matrix}( {x}_{rk} , {( {y}_{rk} )}_{min} ) , \\ … , \\ ( {x}_{rk} , {( {y}_{rk} )}_{max}\end{matrix} \vert \begin{matrix}( {x}_{rk} , {y}_{rk} ) ∈ {Φ}_{k} , \\ rk = 1 , 2 , 3 … {rk}_{max} , \\ k is odd\end{matrix} \} \\ \{ \begin{matrix}( {x}_{rk} , {( {y}_{rk} )}_{max} ) , \\ … , \\ ( {x}_{rk} , {( {y}_{rk} )}_{min}\end{matrix} \vert \begin{matrix}( {x}_{rk} , {y}_{rk} ) ∈ {Φ}_{k} , \\ rk = 1 , 2 , 3 … {rk}_{max} , \\ k is even\end{matrix} \}\end{matrix} , k ∈ K$$

wherein, Ωₖ is the set of circle center coordinates formed by sorting the circle center coordinates of unordered and uniform texturing points in the focal point coverage Λₖ during the k-th processing process according to the processing sequence of the texturing points; (x_{τk}, y_{τk}) is the coordinate of the τk-th processing texturing point in the k-th processing process; τk is the processing sequence number of the texturing points in the k-th processing process; rkₘₐₓ is the maximum statistical value of the number of unordered and uniform texturing points included in the focal point coverage Λₖ during the k-th processing process; (yᵣₖ)ₘₐₓ is the maximum value of y-axis coordinates of the circle center coordinates (xᵣₖ, yᵣₖ) of unordered and uniform texturing points in the focal point coverage Λₖ during the k-th processing process; (yᵣₖ)ₘᵢₙ is the minimum value of y-axis coordinates of the circle center coordinates (xᵣₖ, yᵣₖ) of unordered and uniform texturing points in the focal point coverage Λₖ during the k-th processing process;

Finding the set MSPₖ of processing singular points in Ωₖ: search the set MSPₖ of processing singular points in Ωₖ according to the response frequency of the processing system. The specific searching method is as follows:

$${MSP}_{k} = \{ {msp}_{m k} \vert \begin{matrix}{msp}_{mk} = τ k , \\ \frac{\vert {y}_{τ k} - {y}_{τ k - 1} \vert}{π * n * d} < \frac{1}{F} or \frac{\vert {y}_{τ k} - {y}_{τ k + 1} \vert}{π * n * d} < \frac{1}{F} , \\ ( {x}_{τ k} , {y}_{τ k} ) ∈ {Ω}_{k} , \\ τ k = 2 , 3 , 4 … {rk}_{max} - 1 , \\ mk = 1 , 2 , 3 …\end{matrix} \} , k ∈ K , \\ where F = \frac{1}{ϱ} * min ( MaxfLa {s}_{mor} , Maxf {P}_{res} , Maxf E {X}_{res} , \frac{n}{{R}_{e n c o d e r}} )$$

wherein, MSPₖ is the set of the processing singular points in Ωₖ; mspₘₖ is the processing sequence number of the processing singular points in the k-th processing process; F is the comprehensive response frequency of the processing system; MaxfLas,ₘₒᵣ, is the maximum output frequency of output laser for processing the mor-th morphology; MaxfPᵣₑₛ is the highest response frequency of the beam energy regulation unit; MaxfEXᵣₑₛ, is the highest response frequency of the one-dimensional beam deflection unit; R_{encoder} is the resolution of the encoder rotationally and coaxially mounted with the roller; [symbol] is the safety factor of the response frequency of the system;

Estimating whether there is a processing singular point: when MSPₖ≠Ø, and k ΣK, then there is a processing singular point, the set Ωₖ of the circle center coordinates of unordered and uniform texturing points which are arranged according to the processing sequence in the focal point coverage Λₖ during the k-th processing process is adjusted according to the set MSPₖ of the processing singular points in Ωₖ. The steps of determining set Ωₖ of circle center coordinates of the texturing points after sorting in the k-th processing process and finding the set MSPₖ of processing singular points in Ωₖ are repeated until MSPₖ=Ø. While SP=Ø, there is no bad point.

When MSPₖØ, and k ∈ K, calculating the set ΓLineₘ of signal set of laser output position signal-the beam energy regulation signal-deflection signal of one-dimensional beam deflection unit of the laser terminal output module:

$$Γ {Line}_{m} = \{ Γ {Line}_{m} , k = 1 , 2 , 3 … {k}_{max} \} , m ∈ \{ 1 , 2 , 3 … {m}_{max} \} , \\ where$$

$$Γ {Line}_{{m}_{k}} = \{ ( {β}_{τ k} , ψ {m}_{τ k} , {ξ}_{τ k} ) \vert \begin{matrix}{β}_{τ k} = 2 π \frac{{y}_{τ k}}{π d} , \\ ψ {m}_{τ k} = rand ( {ψ}_{min} , ϛ * {ψ}_{max} ) or \\ ψ {m}_{τ k} = {ψ}_{min} , \\ \{ \begin{matrix}{σ}_{τ k} = {x}_{τ k} - {xk}_{min} ( y = {y}_{τ k} , p = {p}_{τ k} ) \\ {p}_{τ k} = ⌈ \frac{{x}_{τ k} - {xk}_{min} ( y = {y}_{τ k} , p = 1 )}{π d cot θ} ⌉ , \\ {σ}_{τ k} = f ( {α}_{τ k} ) = f ( α ( {ξ}_{τ k} ) )\end{matrix} \\ ( {x}_{τ k} , {y}_{τ k} ) ∈ {Ω}_{k} , τ k = 1 , 2 , 3 … {r}_{max}\end{matrix} \} , \\ k ϵ K , m ∈ \{ 1 , 2 , 3 … {m}_{max} \} ,$$

wherein, ΓLineₘ is the set of the signal set of laser output position signal-the beam energy regulation signal-deflection signal of one-dimensional beam deflection unit of the m-th laser terminal output module during each processing process; ΓLineₘ_{ₖ} is the signal set of laser output position signal-the beam energy regulation signal-deflection signal of one-dimensional beam deflection unit needed by the m-th laser terminal output module for unordered and uniform texturing points which are arranged according to the sequence of processing in the focal point coverage during the k-th processing process; (β_{τk}, ψm_{τk}, ξ_{τk}) is the same laser output position signal, the beam energy regulation signal of the m-th laser terminal output module, and the same deflection signal of one-dimensional beam deflection unit sent to the processing system during processing of the τk-t texturing point in the k-th processing process; p_{τk} is the number of turns for processing the τk-th texturing point during the k-th processing process; ζ is the maximum attenuation ratio constant of laser energy of the beam energy regulation unit.

Furthermore, the set Ωₖ of the circle center coordinates of unordered and uniform texturing points which are arranged according to the sequence of processing in the focal point coverage Λₖ during the k-th processing process is adjusted according to the set MSPₖ of the processing singular points in Ωₖ, as follows specifically:

$${Ω}_{k} = \{ ( {x}_{τ k} , {y}_{τ k} ) \vert \begin{matrix}( {x}_{τ k} , {y}_{τ k} ) = ( {xre}_{τ k} , {yre}_{τ k} ) , \\ ( {xre}_{τ k} , {yre}_{τ k} ) ∈ Ω {re}_{k} \\ τ k = 2 , 3 , 4 … {rk}_{max}\end{matrix} \} , k ∈ K$$

$$where Ω {re}_{k} = \{ ( x r {e}_{τ k} , y r {e}_{τ k} ) \vert \begin{matrix}( {xre}_{τ k} , {yre}_{τ k} ) \\ = \{ \begin{matrix}\{ \begin{matrix}( {x}_{τ k} , {y}_{τ k} - {Δ}_{τ k} ) , k is odd \\ ( {x}_{τ k} , {y}_{τ k} - {Δ}_{τ k} ) , k is even\end{matrix} , \\ τ k ∈ {MSP}_{k} \\ ( {x}_{τ k} , {y}_{τ k} ) , τ k ∉ {MSP}_{k}\end{matrix} , \\ ( {x}_{τ k} , {y}_{τ k} ) ∈ {Ω}_{k} , \\ {Δ}_{τ k} = γ * \vert {y}_{τ k} - {y}_{τ k - 1} \vert , \\ τ k = 2 , 3 , 4 … {rk}_{max}\end{matrix} \} , k ∈ K$$

wherein, Ωreₖ is the adjusted set of the circle center coordinates of unordered and uniform texturing points which are arranged according to the sequence of processing in the focal point coverage Λₖ during the k-th processing process; (xre_{τk}, yre_{τk}) is the adjusted circle center coordinate of the τk-th texturing point processed during the k-th processing process; Δ_{τk} is the adjustment amount of y-axis of the circle center coordinate of the τk-th texturing point processed during the k-th processing process; γ is the adjustment ratio of the adjustment amount of y-axis coordinate.

Furthermore, the method for determining the morphologic distribution dot spacing a and the morphologic distribution line spacing b is as follows:

Determining the type of morphology of laser texturing hard points;

According to the initial value ρ0 of area occupancy, calculating the initial value α0 of the morphologic dot spacing and the initial value b0 of morphologic line spacing, as follows specifically:

$$a 0 = b 0 = \sqrt{\frac{{π ( {D}_{mor} / 2 )}^{2}}{ρ 0}}$$

wherein, ρ0 is the preset initial value of the morphological area occupancy; α0 is the initial value of the morphologic distribution dot spacing, which is the initial value of the distance between two texturing hard points in the x direction; b0 is the initial value of the morphologic distribution line spacing, which is the initial value of the distance between two texturing hard points in they direction; Dₘₒᵣ is the diameter of the mor-th morphology.

Correcting morphologic distribution dot spacing, morphologic distribution line spacing and area occupancy, as follows specifically:

$$a = b = \frac{π d}{⌊ π d / b 0 ⌋} , ρ = \frac{{π ( {D}_{m o r} / 2 )}^{2}}{a * b} ,$$

wherein, ρ is the area occupancy of morphology; α is the morphologic distribution dot spacing, which is the distance between two texturing hard points in the x direction; b is the morphologic distribution line spacing, which is the distance between two texturing hard points in the y direction.

A roller laser texturing processing equipment, comprising a computer, a light source module and a laser terminal output module. The computer comprises the design module for end-to-end, unordered and uniform lattice distribution and signal processing module; according to the roller processing unit parameters and morphological parameters, the scheme of end-to-end, unordered and uniform texturing lattice distribution is output by the design module for end-to-end, unordered and uniform lattice distribution; according to the scheme of end-to-end, unordered and uniform texturing lattice distribution, the machine tool parameters and laser parameters, the laser output position signal, beam energy regulation signal and deflection signal of one-dimensional beam deflection unit are obtained through the information processing module.

The laser output position signal is used to control the light source module to emit the laser;

The beam energy regulation signal and deflection signal of one-dimensional beam deflection unit are input into the laser terminal output module, respectively, to generate an unordered laser lattice, and each laser terminal output module is used to process a roller processing unit.

Each of the laser terminal output module reciprocates axially in the corresponding roller processing unit area. The initial line of the reciprocating motion is

$$x = - \frac{π d}{{k}_{max}} cot θ ,$$

and the termination line is x=L₁.

The beneficial effects of the present invention are:
1. Through the design method of end-to-end, unordered and uniform lattice distribution, the method for roller laser texturing processing described in the present invention can ensure the unordered degree of the texturing points and the uniformity of the morphology distribution at the same time, and consistency of the surface of the produced cold rolled plate is better in the subsequent coating treatment.
2. The method for roller laser texturing processing described in the present invention can precisely and accurately process the designed scheme of unordered and uniform distribution of the texturing points, so as to achieve the objective that the produced is the designed.
3. The method for roller laser texturing processing described in the present invention provides the possibility for the processing modes of a plurality of laser terminal output modules, because the scheme of end-to-end, unordered and uniform texturing lattice distribution is obtained by the design method of end-to-end, unordered and uniform lattice distribution.
4.The present invention adopts laser melting processing technology to obtain the texturing morphology, the morphology hardness is higher than that of the base material, the service life of the morphology is longer, which can guarantee that the surface stability of the cold-rolled plates produced in the same batch is better. Meanwhile, the texturing processing is equivalent to laser quenching on the surface of roller, so it can effectively prolong the service life of the roller.
5. The present invention provides many types of texturing morphologies, and the microscopic size of the morphologies can be precisely regulated and controlled by changing laser parameters, so the present invention can meet the production of various types of cold-rolled plates with different requirements.
6. The texturing morphologies processed by the present invention are concave-convex composite morphologies, the micro-concave part of morphology can store lubricating oil to improve the lubrication conditions in the processing of cold-rolled plate, and the micro-convex portion can be inserted into the surface of cold-rolled plate, reduce the relative movement between the cold-rolled plate and the roller, and effectively prevent scratches on the surface of the cold-rolled plate and roller abrasion in the processing of the cold-rolled plate. At the same time, after the morphology is copied to the surface of the cold-rolled plate, a mechanical anchoring group can be formed between the cold-rolled plate and the coating layer, which solves the problem of peeling off of the coating layer and provides a solution for the problem of inconsistency of thermal sensitivity between the cold-rolled plate and the coating layer.
7. In the present invention, the distribution scheme of texturing points is provided, laser output control signal is calculated by computer, and then the control signal set is sent to the processing control system of the machine tool, so that the production process is effectively simplified, and it is convenient for the enterprises to cope with the production of various types of cold-rolled plates with different requirements, and the calculation efficiency and the calculation accuracy are effectively guaranteed, and at the same time the normal production task of the machine tool will not be affected, and the manufacturing cost of the machine tool can be effectively reduced.

### DESCRIPTION OF DRAWINGS

FIG. 1 is a diagram of the installation position of the laser terminal output module mentioned in the present invention.

FIG. 2 is a diagram of the control schematic of the equipment for roller laser texturing processing mentioned in the present invention.

FIG. 3 is a flow diagram of the design method of the scheme of unordered and uniform laser texturing lattice mentioned in the present invention.

FIG. 4 is a flow diagram of the information processing module mentioned in the present invention.

FIG. 5 is a schematic diagram of division of the processing area mentioned in the present invention.

FIG. 6 is a diagram of the texturing morphologies mentioned in the present invention.

FIG. 7 is a diagram of the scheme of uniform lattice mentioned in the present invention.

FIG. 8 is a diagram of the scheme of random displacement for the scheme of uniform lattice mentioned in the present invention.

FIG. 9 is a diagram of the scheme of bad points processing for the scheme of unordered lattice mentioned in the present invention.

FIG. 10 is a schematic diagram of the lattice distribution of each processing unit is exchanged from left to right with reference to the center line.

FIG. 11 is a diagram of the focal point coverage during the k-th processing process mentioned in the present invention.

FIG. 12 is a diagram of the processing sequence number of the texturing points in the focal point coverage during the k-th (k is odd) processing process mentioned in the present invention.

FIG. 13 is a diagram of the processing sequence number of the texturing points in the focal point coverage during the k-th (k is even) processing process mentioned in the present invention.

FIG. 14 is a diagram of the judgment of processing singular points during the k-th processing process mentioned in the present invention.

FIG. 15 is a diagram of the processing of processing singular points during the k-th processing process mentioned in the present invention.

As shown in the figure:

1-metal cylinder to be processed; 2-coaxial encode; 3-the device for laser focusing; 4-one-dimensional beam deflection unit; 5-beam energy regulating unit; 6-beam back-turning unit; 7-laser terminal output module mounting base

### Embodiments

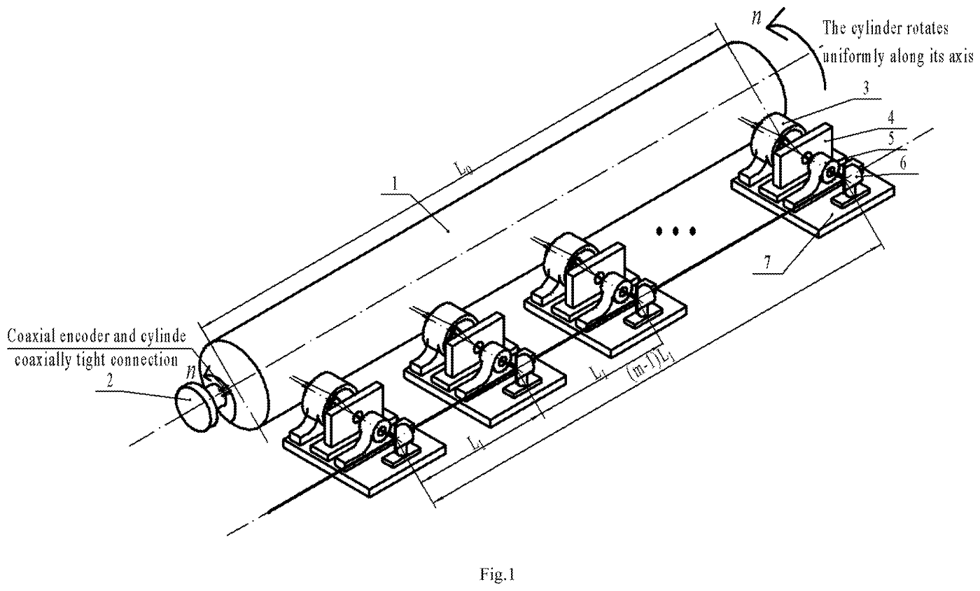

The present invention will be further explained below in combination with the attached drawings and specific embodiments, but the scope of protection of the invention is not limited to this. As shown in FIG. 1, the equipment for roller laser texturing processing described in the present invention, comprising a computer, a light source module and a laser terminal output module. The computer comprises the design module for end-to-end, unordered and uniform lattice distribution and signal processing module; according to the roller processing unit parameters and morphological parameters, the scheme of end-to-end, unordered and uniform texturing lattice distribution is output by the design module for end-to-end, unordered and uniform lattice distribution; according to the scheme of end-to-end, unordered and uniform texturing lattice distribution, the machine tool parameters and laser parameters, the laser output position signal, beam energy regulation signal and deflection signal of one-dimensional beam deflection unit are obtained through the information processing module. The laser output position signal is used to control the light source module to emit the laser; the beam energy regulation signal and deflection signal of one-dimensional beam deflection unit are input into the laser terminal output module, respectively, to generate an unordered laser lattice, and each laser terminal output module is used to process a roller processing unit. Each of the laser terminal output module reciprocates axially in the corresponding roller processing unit area.

The laser terminal output module includes beam back-turning unit 6, beam energy regulation unit 5 and one-dimensional beam deflection unit 4; the incident laser from said light source module passes successively through the beam back-turning unit 6, beam energy regulation unit 5, one-dimensional beam deflection unit 4 and laser focusing device 3, and then into the roller processing unit; said beam back-turning unit 6 is used to split the incident laser from the light source module into a reflected laser perpendicular to the axis direction of the roller and a transmitted laser parallel to the axis direction of the roller; said reflected laser enters into the beam energy regulating unit 5, and said transmitted laser enters into the next laser terminal output module; said beam energy regulating unit 5 is used to change the energy of said reflected laser; said one-dimensional beam deflection unit 4 is used to offset the angle of said reflected laser. Said laser focusing device 3 is used to focus the offset reflected laser onto the metal cylinder 1 to be processed. Since the laser focusing device 3 is an existing device, the structure and principle are not described here. Said laser terminal output module is mounted on the laser terminal output module mounting base 7, and the said laser terminal output module mounting base 7 is axially reciprocated along the roller processing unit region.

The said laser terminal output module is numbered in the sequence from near to far with the laser source, which is marked as: Line₁, Line₂. . . Lineₘ. . . Lineₘ_{ₘₐₓ}, processing the first unit, the second unit. . . the m-th unit until the mₘₐₓ-th unit respectively.

Said beam back-turning unit 6 divides the incident laser into a number of output lasers with equal energy using a number of semi-reflective lenses, which has the following characteristics: based on the different coating properties of each semi-reflective lens, the beam back-turning unit 6 can split the incident laser energy into reflected laser and transmitted laser with specific energy. The beam back-turning unit 6 can split the incident laser which is parallel to the axis direction of the roller into a reflected laser perpendicular to the axis direction of the roller and a transmitted laser parallel to the axis direction of the roller, wherein the energy ratio split by the beam back-turning unit 6 in the Lineₘ-th laser terminal output module is:

$$\frac{{P}_{m}}{{P}_{{m}^{-}}} = 1 : ( {m}_{max} - m ) ;$$

With this method, the energy of input laser in each laser terminal output module can be made to be consistent, that is

$${P}_{m} = {P}_{output} = \frac{1}{{m}_{max}} {P}_{input} , m = 1 , 2 , 3 … {m}_{max} ;$$

where Pₘ is the power of reflected laser split by the beam back-turning unit in the Lineₘ-th laser terminal output module; Pₘ—is the power of transmitted laser split by the beam back-turning unit in the Lineₘ-th laser terminal output module; Pᵢₙₚᵤₜ is the power of laser source output by the laser source module; Pₒᵤₜₚᵤₜ is the laser power input by the laser terminal output module.

Said beam energy regulating unit 5 can change the energy of the laser through the input electric signal of the driving power supply of the beam energy regulating unit, and has the following characteristics: it attenuates the beam energy at a fixed value based on the input electrical signal, that is P_{focus}=(1-Damp(ψ)Pₒᵤₜₚᵤₜ. The electrical signal ip can change continuously and has a fixed range, that is ψ ∈ [ψₘᵢₙ, ψₘₐₓ], and the corresponding energy attenuation ratio Damp(ψ) varies from 0 to 100%.

wherein, ψ is the input electric signal of the driving power supply of the beam energy regulating unit 5; ψₘᵢₙ is the minimum input electrical signal; ψₘₐₓ is the maximum input electrical signal; Damp(ψ) is the laser energy attenuation ratio; P_{focus} is the laser power output by said beam energy regulating unit;

Said one-dimensional beam deflection unit 4 has the following characteristics: it makes the beam deflect in one-dimension at a fixed angle α according to the input electrical signal ξ, that is α=α(ξ); makes the beam deflection angle α in one-dimensional has a fixed range, and αₘₐₓ is an inherent property of the one-dimensional beam deflection unit 4; has a fixed highest response frequency Maxfᵣₑₛ, Maxfᵣₑₛ≥10 Khz and makes the beam deflect in one-dimension at a fixed angle α, then the beam passes through the focus lens and acts on the area to be processed, so as to make focal point offset a determined distance σ relative to the optical axis,

σ=f(α)=f(α(ξ) )

σₘᵢₙ=f(α=αₘᵢₙ=0)=0

σₘₐₓ=f(α=η*αₘₐₓ)

where αₘₐₓ=0.1˜1 rad; α ∈ [0, η* 60 ₘₐₓ]; η ∈ [50%, 80%];

wherein, L₂ is the distance between said one-dimensional beam deflection unit 4 and the surface of the workpiece;f is the focal length when said one-dimensional beam deflection unit 4 does not deflect; α is the deflection angle of beam caused by the one-dimensional beam deflecting unit 4, that is α=α(ξ); αₘᵢₙ is the minimum deflection angle of beam caused by the one-dimensional beam deflecting unit 4; αₘₐₓ is the maximum deflection angle of beam caused by the one-dimensional beam deflecting unit 4; η is the safety service factor of one-dimensional beam deflection unit 4; σ is the offset of focal position; σₘᵢₙ is the minimum offset of focal position; σₘₐₓ is the maximum offset of focal position. Maxfᵣₑₛ is the highest response frequency of one-dimensional beam deflection unit.

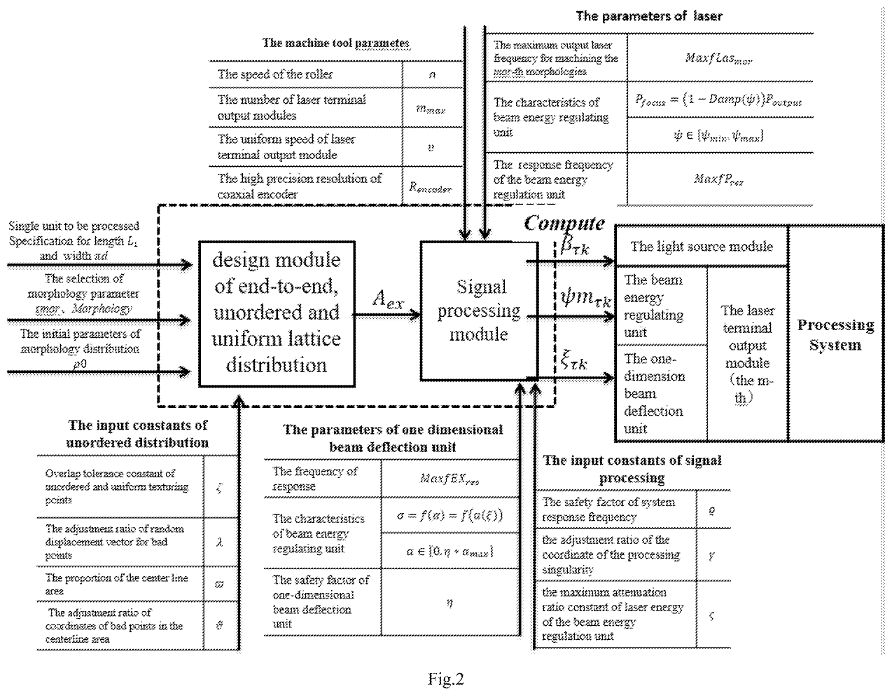

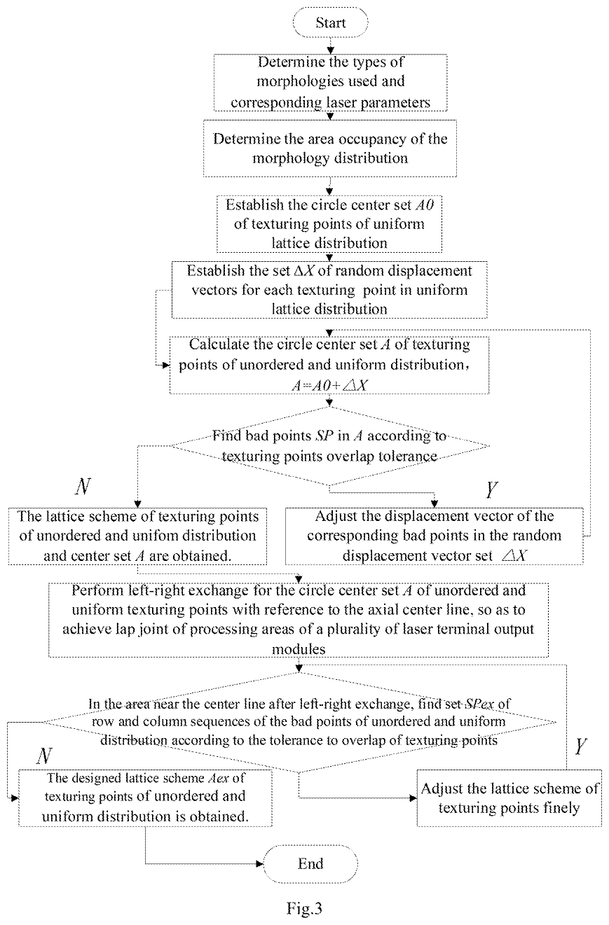

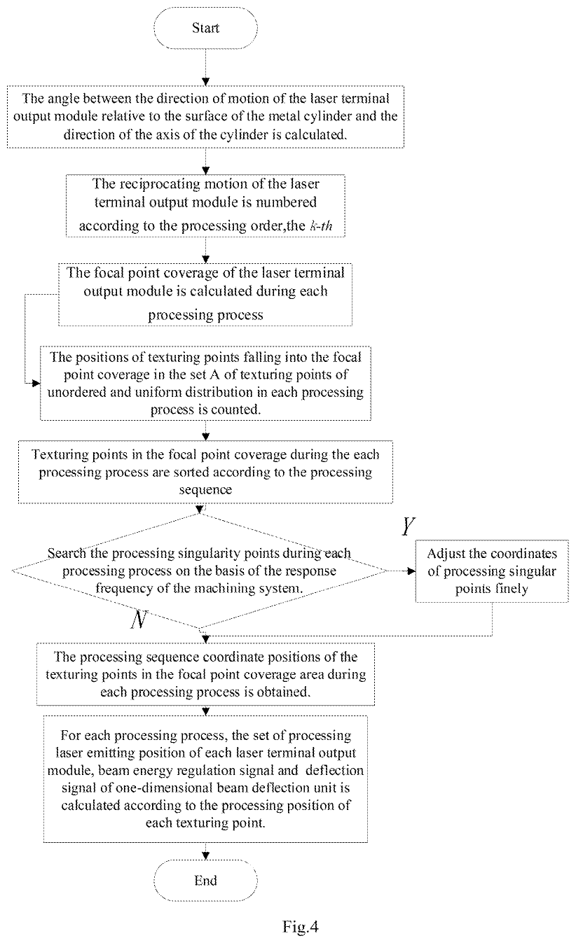

As shown in FIG. 2, FIG. 3 and FIG. 4, the method for roller laser texturing processing described in the present invention includes the following steps:

S01 dividing the processing zone: the roller surface processing zone is evenly divided into several roller processing units, which is as shows specifically in FIG. 5:

Determining the roller surface processing zone; said roller processing zone being a square area with length L₀₁ and width πd, wherein, L₀₁=5%-100%L₀, L₀₋₀₁ is the distance from the end face of roller, L₀₋₀₁=0˜90%L₀; L₀ is the developed length of the roller surface, and d is the diameter of the roller;

The processing zone of roller is evenly divided into m roller processing units, and the length of any roller processing unit is L₁,

$${L}_{1} = \frac{1}{{m}_{max}} {L}_{01} ;$$

the width of any roller processing unit is πd; wherein, m ∈ {1,2,3. . . mₘₐₓ}=1˜30.

S02 Determining the scheme of distribution: according to the mentioned roller processing unit parameters and morphological parameters, the distribution scheme of end-to-end, unordered and uniformly distributed texturing lattice is obtained by the design method of end-to-end, unordered and uniformly distributed lattice, which is as follows specifically:

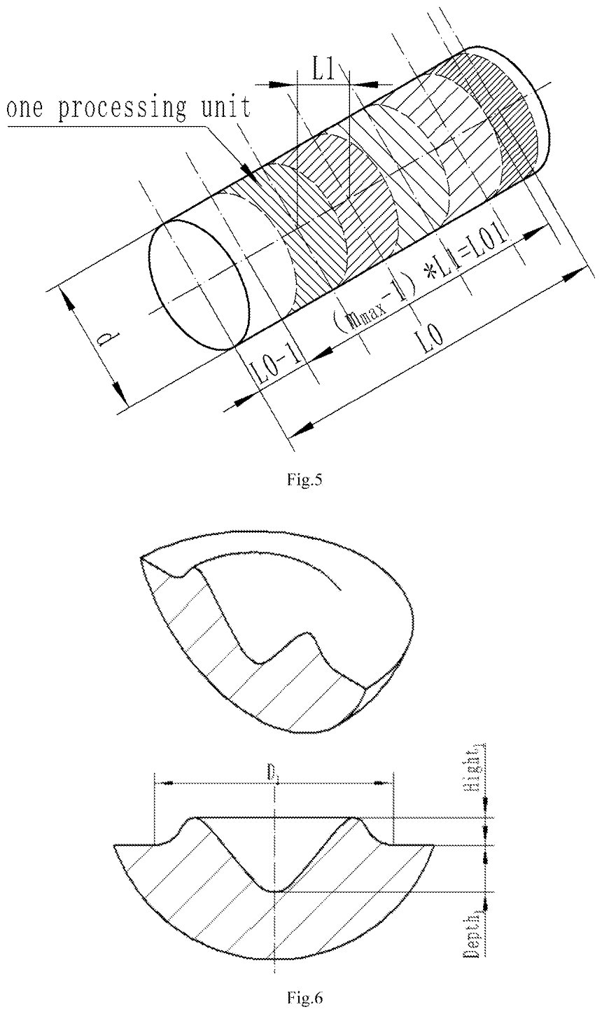

As shown in FIG. 6, setting the texturing hard points as texturing morphology which is produced by laser melting. It can be divided into spherical crown texturing point, Mexican cap-like texturing point and crater-like texturing point according to the cross section of the morphology. The specific morphological parameters are as follows:

$$Morphology = \{ {B}_{mor} \vert \begin{matrix}{B}_{mor} = ( {D}_{mor} , {Depth}_{mor} , {H}_{mor} ) \\ mor = 1 , 2 , 3\end{matrix} , \}$$

$$where$$

$${B}_{1} = ( 30 \text{∼} 200 , 0 \text{∼} 5 , 3 \text{∼} 30 ) μ m$$

$${B}_{2} = ( 30 \text{\textasciitilde} 300 , 1 \text{\textasciitilde} 15 , 3 \text{∼} 30 ) μ m$$

$${B}_{3} = ( 30 \text{∼} 300 , 1 \text{∼} 30 , 1 \text{∼} 10 ) μ m$$

The output laser parameters used in the texturing hard points processing include laser pulse width, laser power, highest laser output frequency and auxiliary gas, which are as follows:

$$Laer = \{ {laser}_{mor} \vert {laser}_{mor} = \begin{matrix}( \begin{matrix}{PluseWidth}_{mor} , {P}_{{focus}_{mor}} , \\ Maxf {Las}_{mor} , {Gas}_{mor}\end{matrix} ) \\ mor = 1 , 2 , 3\end{matrix} , \}$$

$${laser}_{1} = ( \begin{matrix}1 μ s \sim 100 ms , & 10 \sim 200 W \\ 50 Hz \sim 20 KHz , & {N}_{2} or {Ar}_{2} or is high pressure air\end{matrix} )$$

$${laser}_{2} = ( \begin{matrix}150 μ s \sim 100 ms , & 10 \sim 200 W , \\ 50 Hz \sim 10 KHz , & {N}_{2} or {Ar}_{2} or is high pressure air\end{matrix} )$$

$${laser}_{3} = ( \begin{matrix}300 μ s \sim 100 ms , & 10 \sim 200 W , \\ 50 Hz \sim 5 KHz , & {N}_{2} or {Ar}_{2} or is high pressure air\end{matrix} )$$

where Morphology is the set of morphological parameters;Bₘₒᵣ is the morphological parameter of the mor-th morphology; Dₘₒᵣ is the diameter of the mor-th morphology; Depthₘₒᵣ is the depth of the mor-th morphology; Hₘₒᵣₑ is the height of the mor-th morphology; mor is the sequence of the morphology, mor=1,2,3 represents crater-like texturing point, spherical crown texturing point and Mexican cap-like texturing point which are produced by laser melting, respectively. Laser is the set of laser processing parameters of morphology; Laserₘₒᵣ is the laser processing parameter of the mor-th morphology; PluseWidthₘₒᵣₑ is the laser processing pulse width of the mor-th morphology; P_{focus}_{ₘₒᵣ} is the laser processing power of the mor-th morphology; Maxf Lasₘₒᵣ is the highest laser output frequency of the mor-th morphology; Gasₘₒᵣ is the type of auxiliary gas for laser processing of the mor-th morphology.

Step 1-1: Establishing the Cartesian coordinate system and expanding the area of the unit to be processed along the axis direction to form a square surface with length and width of L₁ and πd, respectively. The initial texturing point is taken as the coordinate origin, the axial direction is the x-axis, and the circumference direction is the y-axis. According to the distribution of morphology, the circle center set A₀ of texturing points of uniform lattice distribution is established, and the detailed steps are as follows, step 1-1-S1 to step 1-1-S4:

Step 1-1-S1: Determining the type of morphology of laser texturing hard points and the value of mor.

Step 1-1-S2: According to the initial value ρ0 of area occupancy, calculating the initial value α0 of the morphologic dot spacing and the initial value b0 of morphologic line spacing, as follows specifically:

$$a 0 = b 0 = \sqrt{\frac{{π ( {D}_{mor} / 2 )}^{2}}{ρ 0}} ,$$

wherein, ρ0 is the preset initial value of the morphological area occupancy, ρ0=50% in general; α0 is the initial value of the morphologic distribution dot spacing, which is the initial value of the distance between two texturing hard points in the x direction; b0 is the initial value of the morphologic distribution line spacing, which is the initial value of the distance between two texturing hard points in they direction; Dₘₒᵣ is the diameter of the mor-th morphology.

Step 1-1-S3: Correcting morphologic distribution dot spacing, morphologic distribution line spacing and area occupancy, as follows specifically:

$$a = b = \frac{π d}{⌊ π d / b 0 ⌋} , \\ ρ = \frac{{π ( {D}_{mor} / 2 )}^{2}}{a * b} ,$$

wherein, ρ is the area occupancy of morphology; a is the morphologic distribution dot spacing, which is the distance between two texturing hard points in the x direction; b is the morphologic distribution line spacing, which is the distance between two texturing hard points in the y direction.

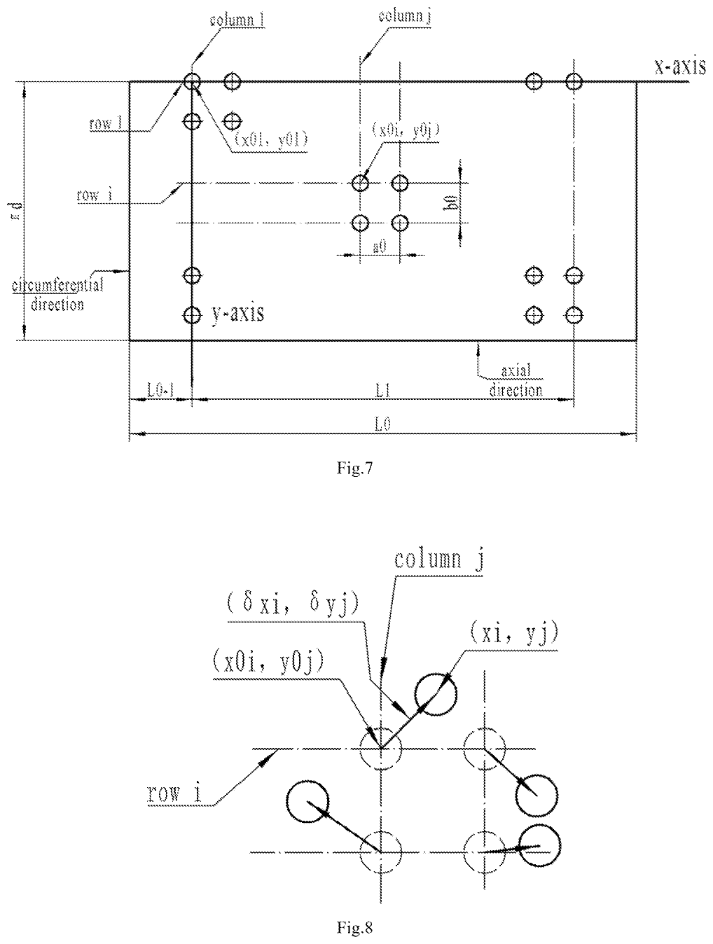

Step 1-1-S4: As shown in FIG. 7, according to morphologic distribution dot spacing, morphologic distribution line spacing, establishing the circle center set A₀ of texturing points of uniform lattice distribution, which is as follows specifically:

wherein, A₀ is the set of circle center coordinates of texturing points of uniform lattice distribution; (x₀ᵢ, y₀ᵢ) is the circle center coordinate of texturing point of uniform lattice distribution in row i and column j; i represents the row serial number; iₘₐₓ is the maximum row serial number; iₘₐₓ=πd/b; j represents the column serial number; jₘₐₓ=[L₁/α]+1; jₘₐₓ is the maximum column serial number; α is the morphologic distribution dot spacing, which is the distance between two texturing hard points in the x direction; b is morphologic distribution line spacing, which is the distance between two texturing hard points in they direction;

Step 1-2: As shown in FIG. 8, establishing the set ΔX of random displacement vectors for each texturing point in uniform lattice distribution, which is as follows specifically:

$$Δ X = \{ ( δ {x}_{i} δ {y}_{j} ) \vert \begin{matrix}δ {x}_{i} = rand ( - 1 , 1 ) * {ɛ}_{b} , \\ δ {y}_{j} = rand ( - 1 , 1 ) * {ɛ}_{a} , \\ i = 1 , 2 , 3 … {i}_{max} , j = 1 , 2 , 3 … {j}_{max}\end{matrix} \}$$

wherein, ΔX is the set of random displacement vectors for each texturing point in uniform lattice distribution; (δxᵢ, δyⱼ) is the random displacement vector of the circle center coordinate(x₀ᵢ, y₀ⱼ) of the texturing points of uniform lattice distribution in row i and column j in the uniform lattice distribution; ε_{α} is the constant of column offset, εₐ ∈ (0, 2α] in general; ε_{b} is the constant of row offset, ε_{b} ∈ (0, 2b] in general, and εₐ=ε_{b};

Step 1-3: Calculating the circle center set A of texturing points of unordered and uniform distribution by adding the set A₀ of circle center coordinates of texturing points of uniform lattice distribution to the set ΔX of random displacement vectors for each texturing point in uniform lattice distribution, as follows:

$$A = {A}_{0} + Δ X = \{ ( {x}_{i} , {y}_{j} ) \vert \begin{matrix}( {x}_{i} , {y}_{j} ) = ( {x}_{0 i} , {y}_{0 j} ) + ( δ {x}_{i} , δ {y}_{j} ) , \\ i = 1 , 2 , 3 … {i}_{max} , j = 1 , 2 , 3 … {j}_{max}\end{matrix} \}$$

wherein, A is the circle center set of texturing points of unordered and uniform distribution; (xᵢ, yⱼ) is the circle center coordinates of texturing points of unordered and uniform distribution;

Step 1-4: Finding the set SP of row and column sequences of the bad points of unordered and uniform distribution according to the tolerance to overlap of texturing points, as follows specifically:

$$SP = \{ ( {u}_{q} , {w}_{q} ) \vert \begin{matrix}( {u}_{q} , {w}_{q} ) = ( i , j ) , \\ \vert A ( i , j ) - A ( i + 1 , j ) \vert < ζ * D or \\ \vert A ( i , j ) - A ( i , j + 1 ) \vert < ζ * D or \\ \vert A ( i , j ) - A ( i + 1 , j + 1 ) \vert < ζ * D , \\ i = 2 , 3 , 4 … {i}_{max} - 1 , \\ j = 2 , 3 , 4 … {j}_{max} - 1 , \\ q = 1 , 2 , 3 … \end{matrix} \}$$

wherein, SP is the set of row and column sequences of the bad points of unordered and uniform distribution; A(i, j) is the circle center coordinate of texturing points in row i and column j in the set of the center coordinates of texturing points of unordered and uniform distribution in row i and column j; (u_{q}, w_{q}) is the coordinate row and column sequences of the q-th bad point; q is the sequence number of bad point; ζ is an overlap tolerance constant of texturing points of unordered and uniform distribution; ζ ∈ [0.5,1.5] in general;

Step 1-5: Estimating whether there is a bad point and deciding the next step, so as to obtain the circle center set of texturing points of unordered and uniform distribution, as follows:

There are bad points when SP≠ [symbol] , then it is calculated as follows from step 1-5-S1 to step 1-5-S2:

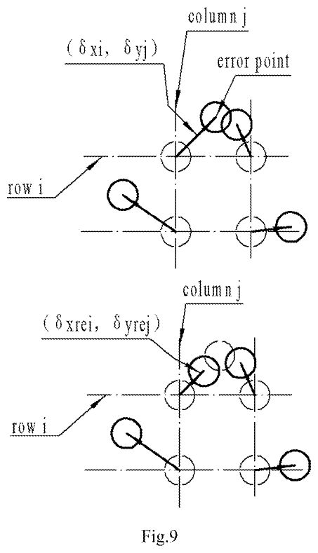

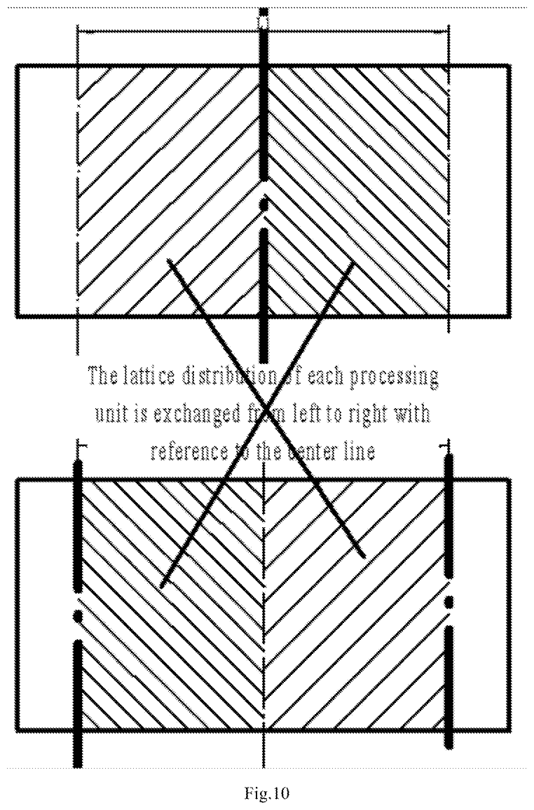

Step 1-5-S1: the random displacement vector set ΔX is adjusted according to the bad points set SP of unordered and uniform distribution, as follows specifically in the FIG. 9:

$$Δ X = \{ ( δ {x}_{i} , δ {y}_{j} ) \vert \begin{matrix}( δ {x}_{i} , δ {y}_{j} ) = ( δ {xre}_{i} , δ {yre}_{j} ) , \\ ( δ {xre}_{i} , δ {yre}_{j} ) ∈ Δ Xre , \\ i = 1 , 2 , 3 … {i}_{max} , j = 1 , 2 , 3 … {j}_{max}\end{matrix} \}$$

$$where Δ Xre = \{ ( δ {xre}_{i} , δ {yre}_{j} ) \vert \begin{matrix}( δ {xre}_{i} , δ {yre}_{j} ) = \{ \begin{matrix}λ ( δ {x}_{i} , δ {y}_{j} , & ( i , j ) ∈ SP \\ ( δ {x}_{i} , δ {y}_{j} ) , & ( i , j ) ∉ SP\end{matrix} , \\ i = 1 , 2 , 3 … {i}_{max} , j = 1 , 2 , 3 … {j}_{max} , \\ ( δ {x}_{i} , δ {y}_{j} ) ∈ Δ X\end{matrix} \}$$

wherein, ΔXre is the adjusted set of random displacement vectors; (δxreᵢ, δyreⱼ) is the adjusted random displacement vector; λ is the adjustment ratio of random displacement vector for a bad point;, λ ∈ (0,1) in general;

Step 1-5-S2: Repeat step 1-3 to step 1-4 until SP=Ø;

While SP=Ø, there are no bad points, then do step 1-6.

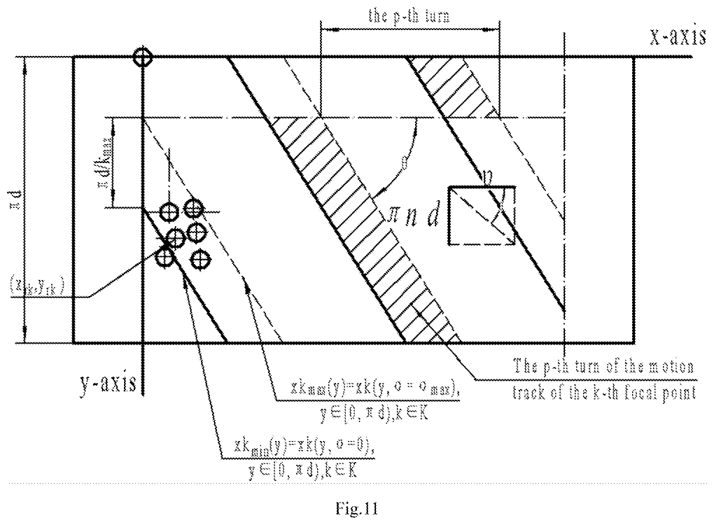

Step 1-6: the circle center set A of texturing points of unordered and uniform distribution is subjected to left-right exchange with reference to the axial center line, so that the lap joint of the processing areas of a number of laser terminal output modules can be achieved, which is as follows specifically in the FIG. 10:

$$Aex = \{ ( {xex}_{i} , {yex}_{j} ) \vert \begin{matrix}( {xex}_{i} , {yex}_{j} ) \{ \begin{matrix}( {x}_{i} + \frac{1}{2} {L}_{1} {y}_{j} ) , & {x}_{i} < \frac{1}{2} {L}_{1} \\ ( {x}_{i} - \frac{1}{2} {L}_{1} {y}_{j} ) , & {x}_{i} \geq \frac{1}{2} {L}_{1}\end{matrix} , \\ ( {x}_{i} , {y}_{j} ) ∈ A , \\ i = 1 , 2 , 3 … {i}_{max} , j = 1 , 2 , 3 … {j}_{max}\end{matrix} \}$$

wherein, Aex is the circle center set of texturing points of unordered and uniform distribution which is obtained through left-right exchange of the circle center set A of texturing points of unordered and uniform distribution with reference to the axial center line; (xexᵢ, yexⱼ) refers to the circle center coordinates of texturing points in row i and column j after left-right exchange;

Step 1-7: In the area near the center line after the process of left-right exchange, find the set SPex of row and column sequences of the bad points of unordered and uniform distribution according to the tolerance to overlap of texturing points, as follows specifically:

$$SPex = \{ ( {uex}_{qex} , {wex}_{qex} ) \vert \begin{matrix}( {uex}_{qex} , {wex}_{qex} ) = ( i , j ) , \\ \vert Aex ( i , j ) - Aex ( i + 1 , j ) \vert < ζ * D or \\ \vert Aex ( i , j ) - Aex ( i , j + 1 ) \vert < ζ * D or \\ \vert Aex ( i , j ) - Aex ( i + 1 , j + 1 ) \vert < ζ * D , \\ Aex ( i , j ) ∈ Center , \\ i = 1 , 2 , 3 … {i}_{max} , \\ j = 1 , 2 , 3 … {j}_{max} , \\ qex = 1 , 2 , 3 … \end{matrix} \}$$

wherein, SPex is the set of row and column sequences of the bad points of unordered and uniform distribution found in the area near the center line after the process of left-right exchange according to the tolerance to overlap of texturing points; (uex_{qex}, wex_{qex}) is the row and column sequences of coordinate of the qex-th bad point; qex is the sequence number of bad point; Aex(i,j) is the circle center coordinates of texturing point in row i and column j in the set of the circle center coordinates of texturing points of unordered and uniform distribution after exchange; Center is the area near the center line after the process of left-right exchange:

$$Center = \{ ( x , y ) \vert x ∈ [ ( 1 - \frac{ϖ}{2} ) \frac{{L}_{1}}{2} , ( 1 + \frac{ϖ}{2} ) \frac{{L}_{1}}{2} ] , y ∈ [ 0 , π d ] \}$$

where ω̅ is the proportion of the area near the input center line, ω̅=1% ∈ (1%, 50%) in general;

Step 1-8: Estimating whether there is a bad point in the area near the center line and deciding the next step, so as to finally obtain the circle center set of texturing points of unordered and uniform distribution, as follows:

There are bad points when SPex≠Ø, then it is calculated as follows from step 1-8-S1 to step 1-8-S2:

Step 1-8-S1: The position of bad points in the area near the centerline is adjusted according to the bad points set SPex of unordered and uniform distribution in the area near the centerline, which is as follows specifically:

$$Aex = \{ ( {xex}_{i} , {yex}_{j} ) \vert \begin{matrix}( {xex}_{i} , {yex}_{j} ) = ( {xre}_{i} , {yre}_{j} ) , \\ ( {xre}_{i} , {yre}_{j} ) ∈ Are , \\ i = 1 , 2 , 3 … {i}_{max} , j = 1 , 2 , 3 … {j}_{max} ,\end{matrix} \}$$

$$where Are = \{ ( {xre}_{i} , {yre}_{j} ) \vert \begin{matrix}( {xre}_{i} , {yre}_{j} ) = \\ \{ \begin{matrix}( {xex}_{i} , {yex}_{j} ) - ϑ ( δ {x}_{i} , δ {y}_{j} ) , & ( i , j ) ∈ SPex \\ ( {xex}_{i} , {yex}_{j} ) , & ( i , j ) ∉ SPex\end{matrix} , \\ , \\ i = 1 , 2 , 3 … {i}_{max} , j = 1 , 2 , 3 … {j}_{max} , \\ ( {xex}_{i} , {yex}_{j} ) ∈ Aex , \\ ( δ {x}_{i} , δ {y}_{j} ) ∈ Δ X\end{matrix} \}$$

wherein, Are is the set of the circle center coordinates of texturing points of unordered and uniform distribution after adjusting the positions of bad points in the area near the centerline; (xreᵢ, yreⱼ) is the circle center coordinate of a texturing point in row i and column j in the set of the circle center coordinates of texturing points of unordered and uniform distribution after adjusting the positions of bad points in the area near the centerline; 19 is the adjustment ratio of coordinates of bad points in the area near the centerline, ϑ=0.1 ∈ (0,0.5) in general.

Step 1-8-S2: Repeat step 1-6 and step 1-7 until SPex=Ø;

While SPex=Ø, there are no bad points, that is, Aex is the designed distribution scheme of unordered and uniformly distributed texturing lattice.

S03 Determining the output signal: on the basis of the mentioned distribution scheme of end-to-end, unordered and uniformly distributed texturing lattice, the machine tool parameters and laser parameters, the laser output position signal, beam energy regulation signal and deflection signal of one-dimensional beam deflection unit are obtained through the information processing module, which is as follows specifically by step 2-1 to step 2-8:

Step 2-1: Calculating the angle between the laser terminal output module relative to the motion direction of the metal cylinder surface and the axis direction of the cylinder, when the one-dimensional beam deflection unit 4 is not working, that is α=0 or the offset σ=0, the angle θ between the motion track of focal point and the axial direction of roller is:

$$θ = {tan}^{- 1} \frac{π * n * d}{υ}$$

where n is rotating speed of the roller; v is the running speed of the laser terminal output module;

Step 2-2: The reciprocating motion of the laser terminal output module is numbered in the processing sequence, that is the set K of focal point motion track sequence number and calculating the set P of the number of turns of each focal point motion track moving around the metal cylinder, as follows specifically:

$$k ∈ K = \{ 1 , 2 , 3 … {k}_{max} \} , \\ where {k}_{max} = \{ \begin{matrix}\frac{π d}{{σ}_{max} tan θ} , & \frac{π d}{{σ}_{max} tan θ} is an integer \\ ⌊ \frac{π d}{{σ}_{max} tan θ} ⌋ + 1 , & \frac{π d}{{σ}_{max} tan θ} is not an integer\end{matrix} ; \\ p ∈ P = \{ 1 , 2 , 3 … {p}_{max} \} , \\ where {p}_{max} = \{ \begin{matrix}\frac{{L}_{1}}{π d cot θ} , & \frac{{L}_{1}}{π d cot θ} is an integer \\ ⌊ \frac{{L}_{1}}{π d cot θ} ⌋ + 1 , & \frac{π d}{π d cot θ} is not an integer\end{matrix}$$

wherein, K is the set of focal point motion track sequence number; k is the k-th focal point motion track, that is, the k-th processing process; P is the set of the number of turns of each focal point motion track moving around the metal cylinder; p is the p-th turn of focal point motion track moving around the metal cylinder;

Step 2-3: As shown in FIG. 11, calculating the set A of focal point coverage Λₖ of laser terminal output module during each processing process, when the deflection angle α of the one-dimensional beam deflection unit 4 is α ∈ [0, η* αₘₐₓ], the set Λ of focal point coverage Λₖ of laser terminal output module during the k-th processing process is determined, as follows specifically:

$$Λ = \{ {Λ}_{k} \vert {Λ}_{k} = \{ ( x , y ) \vert \begin{matrix}\begin{matrix}x ∈ [ {xk}_{min} ( y , p = 1 ) , \\ {xk}_{max} ( y , p = 1 ) ) ⋃\end{matrix} \\ \begin{matrix}[ {xk}_{min} ( y , p = 2 ) , \\ {xk}_{max} ( y , p = 2 ) ) ⋃\end{matrix} \\ \begin{matrix}[ {xk}_{min} ( y , p = 3 ) , \\ {xk}_{max} ( y , p = 3 ) ) ⋃\end{matrix} \\ … ⋃ \\ \begin{matrix}[ {xk}_{min} ( y , p = {p}_{max} ) , \\ {xk}_{max} ( y , p = {p}_{max} ) ) ,\end{matrix} \\ y ∈ [ 0 , π d )\end{matrix} \} , k = 1 , 2 , 3 … {k}_{max} \} , \\ where$$

$${xk}_{min} ( y , p ) = xk ( y , p , σ = 0 ) = \frac{[ y - \frac{π d}{{k}_{max}} k ]}{tan θ} + \frac{π d}{tan θ} ( p - 1 ) , \\ y ∈ [ 0 , π d ) , \\ p ∈ P , \\ k ∈ K , \\ {xk}_{max} ( y , p ) = xk ( y , p , σ = {σ}_{max} ) = \frac{[ y - \frac{π d}{{k}_{max}} ( k - 1 ) ]}{tan θ} + \frac{π d}{tan θ} ( p - 1 ) , \\ y ∈ [ 0 , π d ) , \\ p ∈ P , \\ k ∈ K ,$$

where Λ is the set of focal point coverage of laser terminal output module during each processing process; Λₖ is the focal point coverage of laser terminal output module during the k-th processing process; xkₘᵢₙ(y, p)=xk(y, p, σ=0) is the equation of the p-th turn of the k-th focal point motion track, when the deflection angle α=0, that is, deflection offset σ=0; xkₘₐₓ(y, p)=xk(y, p, σ=σₘₐₓ) is the equation of the p-th turn of the k-th focal point motion track, when the deflection angle α=η* αₘₐₓ, that is, deflection offset σ=σₘₐₓ.

Step 2-4: The set Φ of the circle center coordinates of unordered and uniform texturing points in the focal point coverage of laser terminal output module during each processing process is counted, as follows specifically:

$$Φ = \{ {Φ}_{k} \vert k = 1 , 2 , 3 … {k}_{max} \} , \\ where {Φ}_{k} = \{ ( {x}_{rk} , {y}_{rk} ) \vert \begin{matrix}( {x}_{rk} , {y}_{rk} ) = ( {xex}_{i} , {yex}_{j} ) , \\ ( {xex}_{i} , {yex}_{j} ) {ϵΛ}_{k} , ( {xex}_{i} , {yex}_{j} ) ∈ Aex , \\ i = 1 , 2 , 3 … {i}_{max} , j = 1 , 2 , 3 … {j}_{max} , \\ rk = 1 , 2 , 3 … \end{matrix} \} , \\ k ∈ K ,$$

wherein, Φ is the set of the circle center coordinates of unordered and uniform texturing points in the focal point coverage of laser terminal output module during each processing process; Φₖ is the circle center coordinates of unordered and uniform texturing points in the focal point coverage Λₖ of laser terminal output module during the k-th processing process, that is, the circle center coordinates fall into the set of the circle center coordinates of texturing points between the two trajectories xkₘᵢₙ=xk(y, σ=0) and xkₘₐₓ=xk(y, σ=σₘₐₓ); (xᵣₖ, yᵣₖ) is the circle center coordinate of the rk-th unordered and uniform texturing point included during the k-th processing process; rk is the statistical sequence of unordered and uniform texturing points included in the k-th processing process;

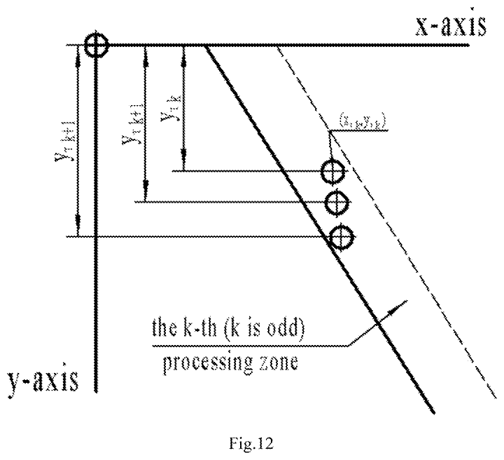

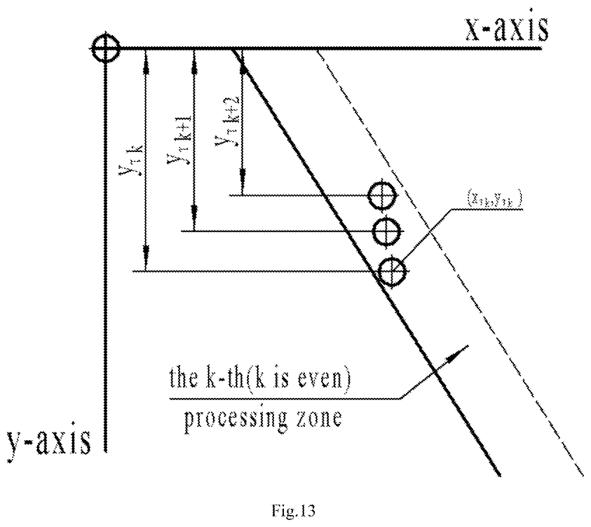

Step 2-5: As shown in FIG. 12 and FIG. 13, the circle center coordinates of unordered and uniform texturing points obtained from statistics in the focal point coverage Λₖ during the k-th processing process are sorted according to the processing sequence of the texturing points to obtain the set Ωₖ of circle center coordinates of the texturing points after sorting. The specific sorting rules are as follows:

$${Ω}_{k} = \{ ( {x}_{τ k} , {y}_{τ k} ) \vert τ k = 1 , 2 , 3 … {rk}_{max} \} = \{ \begin{matrix}\{ \begin{matrix}( {x}_{rk} , {( {y}_{rk} )}_{min} ) , \\ … , \\ ( {x}_{rk} , {( {y}_{rk} )}_{max} )\end{matrix} \vert \begin{matrix}( {x}_{rk} , {y}_{rk} ) ∈ {Φ}_{k} , \\ rk = 1 , 2 , 3 … {rk}_{max} , \\ k is odd\end{matrix} \} \\ \{ \begin{matrix}( {x}_{rk} , {( {y}_{rk} )}_{max} ) \\ … , \\ ( {x}_{rk} , {( {y}_{rk} )}_{min} )\end{matrix} \vert \begin{matrix}( {x}_{rk} , {y}_{rk} ) ∈ {Φ}_{k} , \\ rk = 1 , 2 , 3 … {rk}_{max} , \\ k is even\end{matrix} \}\end{matrix} , \\ k ∈ K$$

wherein, Ωₖ is the set of circle center coordinates formed by sorting the circle center coordinates of unordered and uniform texturing points in the focal point coverage Λₖ during the k-th processing process according to the processing sequence of the texturing points; (x_{τk}, y_{τk}) is the coordinate of the rk-th processing texturing point in the k-th processing process; τk is the processing sequence number of the texturing points in the k-th processing process; rkₘₐₓ is the maximum statistical value of the number of unordered and uniform texturing points included in the focal point coverage Λₖ during the k-th processing process; (yᵣₖ) ₘₐₓ is the maximum value of y-axis coordinates of the circle center coordinates (xᵣₖ, yᵣₖ) of unordered and uniform texturing points in the focal point coverage Λₖ during the k-th processing process; (yᵣₖ)ₘᵢₙ is the minimum value of y-axis coordinates of the circle center coordinates (xᵣₖ, yᵣₖ) of unordered and uniform texturing points in the focal point coverage Λₖ during the k-th processing process;

Step 2-6: Finding the set MSPₖ of processing singular points in the set Ωₖ of the circle center coordinates of unordered and uniform texturing points which are arranged according to the processing sequence in the focal point coverage Λₖ during the k-th processing process according to the response frequency of the processing system. The specific searching method is as follows:

$${MSP}_{k} = \{ {msp}_{mk} \vert \begin{matrix}{msp}_{mk} = τ k \\ \frac{\vert {y}_{τ k} - {y}_{τ k - 1} \vert}{π * d * d} < \frac{1}{F} or \frac{\vert {y}_{τ k} - {y}_{τ k - 1} \vert}{π * d * d} < \frac{1}{F} , \\ ( {x}_{τ k} , y , {y}_{τ k} ) ∈ {Ω}_{k} , \\ τ k = 2 , 3 , 4 … {rk}_{max} - 1 , \\ mk = 1 , 2 , 3 … \end{matrix} \} , \\ k ∈ K , \\ where f = \frac{1}{ϱ} * min ( Maxf {Las}_{mor} , Maxf {P}_{res} , Maxf {EX}_{res} , \frac{n}{{R}_{encoder}} )$$

wherein, MSPₖ is the set of the processing singular points in Ωₖ; mspₘₖ is the processing sequence number of the processing singular points in the k-th processing process; F is the comprehensive response frequency of the processing system; Maxf Las,ₘₒᵣ is the maximum output frequency of output laser for processing the morphology; MaxfPᵣₑₛ is the highest response frequency of the beam energy regulation unit 5; MaxfEXᵣₑₛ is the highest response frequency of the one-dimensional beam deflection unit 4; R_{encoder} is the resolution of the encoder 2 rotationally and coaxially mounted with the roller; [symbol] is the safety factor of the response frequency of the system, [symbol] ∈ (1, 10] in general;

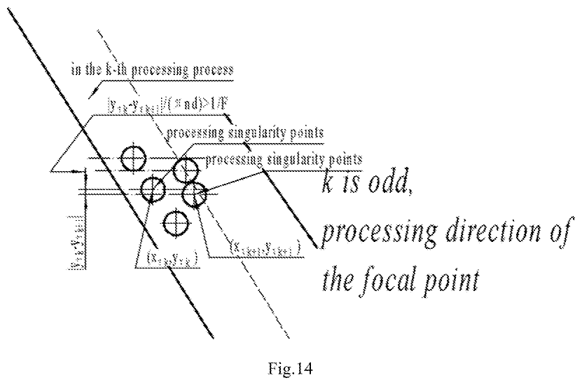

Step 2-7: As shown in FIG. 14, estimating whether there is a processing singular point: when MSPₖ≠Ø, and k ∈ K, then there is a processing singular point, and do steps 2-7-S1-S2;

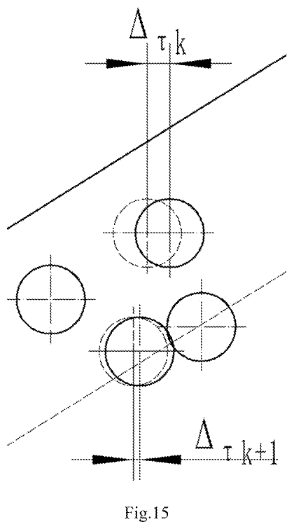

Step 2-7-S1: As shown in FIG. 15, the set Ωₖ of the circle center coordinates of unordered and uniform texturing points which are arranged according to the processing sequence in the focal point coverage Λₖ during the k-th processing process is adjusted according to the set MSPₖ of the processing singular points in Ωₖ, as follows specifically:

$${Ω}_{k} = \{ ( {x}_{τ k} , {y}_{τ k} ) \vert \begin{matrix}( {x}_{τ k} , {y}_{τ k} ) = ( {xre}_{τ k} , {yre}_{τ k} ) , \\ ( {xre}_{τ k} , {yre}_{τ k} ) ∈ Ω {re}_{k} \\ τ k = 2 , 3 , 4 … {rk}_{max}\end{matrix} \} , \\ k ∈ K$$

$$where Ω {re}_{k} = \{ ( {xre}_{τ k} , {yre}_{τ k} ) \vert \begin{matrix}( {xre}_{τ k} , {yre}_{τ k} ) \\ \{ \begin{matrix}\{ \begin{matrix}( {x}_{τ k} , {y}_{τ k} - {Δ}_{τ k} ) , k is odd \\ ( {x}_{τ k} , {y}_{τ k} + {Δ}_{τ k} ) , k is even\end{matrix} , \\ τ k ∈ {MSP}_{k} \\ ( {x}_{τ k} , {y}_{τ k} ) , τ k ∉ {MSP}_{k}\end{matrix} , \\ ( {x}_{τ k} , {y}_{τ k} ) ∈ {Ω}_{k} , \\ {Δ}_{τ k} = γ * \vert {y}_{τ k} - {y}_{τ k - 1} \vert , \\ τ k = 2 , 3 , 4 … {rk}_{max}\end{matrix} \} , \\ k ∈ K$$

wherein, Ωreₖ is the adjusted set of the circle center coordinates of unordered and uniform texturing points which are arranged according to the sequence of processing in the focal point coverage Λₖ during the k-th processing process; (xre_{τk}, yre_{τk}) is the adjusted circle center coordinate of the τk-th texturing point processed during the k-th processing process; Δ_{τk} is the adjustment amount of y-axis of the circle center coordinate of the rk-th texturing point processed during the k-th processing process; γ is the adjustment ratio of the adjustment amount of y-axis coordinate γ ∈ (0, 1) in general.

Step 2-7-S2: Repeat step 2-5 to step 2-6 until MSPₖ=Ø;

When MSPₖ=Ø and k ∈ K, there are no processing singular points, then do the step 2-8.

Step 2-8: Calculating the set ΓLineₘ of signal set of laser output position signal-the beam energy regulation signal-deflection signal of one-dimensional beam deflection unit of each laser terminal output module during each processing process according to the circle center coordinates of unordered and uniform texturing points which are arranged according to the processing sequence in the focal point coverage during each processing process, as follows specifically:

$$Γ {Line}_{m} = \{ Γ {Line}_{{m}_{k}} , k = 1 , 2 , 3 … {k}_{max} \} , \\ m ∈ \{ 1 , 2 , 3 … {m}_{max} \} , \\ where$$

$$Γ {Line}_{{m}_{k}} = \{ ( {β}_{τ k} , ψ {m}_{τ k} , {ξ}_{τ k} ) \vert \begin{matrix}{β}_{τ k} = 2 π \frac{{y}_{τ k}}{π d} , \\ ψ {m}_{τ k} = rand ( {ψ}_{min} , ς * {ψ}_{max} ) or \\ ψ {m}_{τ k} = {ψ}_{min} , \\ \{ \begin{matrix}{σ}_{τ k} = {x}_{τ k} - {xk}_{min} ( y = {y}_{τ k} , p = {p}_{τ k} ) \\ {p}_{τ k} = ⌈ \frac{{x}_{τ k} - {xk}_{min} ( y = {y}_{τ k} , p = 1 )}{π d cot θ} ⌉ , \\ {σ}_{τ k} = f ( {α}_{τ k} ) = f ( α ( {ξ}_{τ k} ) )\end{matrix} \\ ( {x}_{τ k} , {y}_{τ k} ) ∈ {Ω}_{k} , τ k = 1 , 2 , 3 … {r}_{max}\end{matrix} \}$$

$$k ∈ K , \\ m ∈ \{ 1 , 2 , 3 … {m}_{max} \} ,$$

wherein, ΓLineₘ is the set of the signal set of laser output position signal-the beam energy regulation signal-deflection signal of one-dimensional beam deflection unit of the m-th laser terminal output module during each processing process; ΓLineₘ_{ₖ} is the signal set of laser output position signal-the beam energy regulation signal-deflection signal of one-dimensional beam deflection unit needed by the m-th laser terminal output module for unordered and uniform texturing points which are arranged according to the sequence of processing in the focal point coverage during the k-th processing process; (β_{96 k}, ψm_{τk}, ξ_{τk}) is the same laser output position signal, the beam energy regulation signal of the m-th laser terminal output module, and the same deflection signal of one-dimensional beam deflection unit sent to the processing system during processing of the τk-t texturing point in the k-th processing process; p_{τk} is the number of turns for processing the τk-th texturing point during the k-th processing process; c is the maximum attenuation ratio constant of laser energy of the beam energy regulation unit 5, ζ ∈ [10%, 50%] in general.

S04 Laser texturing processing of roller: said laser output position signal is used for controlling the light source module to emit laser; said beam energy regulation signal and deflection signal of one-dimensional beam deflection unit are input into the laser terminal output module, respectively, to generate the unordered laser lattice, each laser terminal output module is used for processing one roller processing unit.

The precise control method comprises the following steps: the metal cylinder 1 to be processed moves synchronously with the laser terminal output module, and the computer automatically determines the parameters of the processing laser after determining the type of morphology to be processed. The laser emitted by the laser source is split for many times enters each laser terminal output module respectively. According to the set of signal set of laser output position signal-the beam energy regulation signal-deflection signal of one-dimensional beam deflection unit of the laser terminal output module calculated by the computer to detect the consistency of the instantaneous position signal of the coaxial encoder 2 and the laser output position signal. When the laser terminal output module is in a determined position, a laser with determined parameters is emitted. Meanwhile, different signals are sent to beam energy regulating unit of each laser terminal output module, so as to complete energy attenuation adjustment, and the same signal is sent to one-dimensional beam deflection unit of each laser terminal output module to complete one-dimensional deflection of beam, so that the laser focus of each laser terminal output module processes the texturing hard points in turn by using different laser energy according to the designed scheme of end-to-end, unordered and uniformly distributed lattice.

Wherein, the synchronous motion of the said roller and the laser terminal output module is the roller, that is, the metal cylinder 1 to be processed rotates uniformly along the axis direction, coaxial encoder 2 rotates synchronously with the roller, the rotational speed is n, and the parameter range is n=200 rpm. While the roller rotates on its own axis, each laser terminal output module makes uniform speed and reciprocating straight line motion along the axis direction, and the reciprocating motion ranges from

$$0 \sim {L}_{1} + \frac{π d}{{k}_{max}} cot θ ,$$

the initial line of said reciprocating motion is

$$x = - \frac{π d}{{k}_{max}} cot θ$$

and the termination line is x=L₁. The velocity of motion υ is in the range of υ=200 mm/s. Laser terminal output module in the process of uniform speed and reciprocating motion, it waits for the time Δt in situ when the movement speed direction changes each time.

Said coaxial encoder 2 has the following characteristics: It has a fixed resolution R_{encoder} of coaxial encoder, which is an inherent attribute of coaxial encoder, and ranges R_{encoder} ∈ [2¹⁶, 2²⁰].

In the mentioned scheme, the laser terminal output module in the process of uniform speed and reciprocating motion, it waits for the time Δt in situ when the movement speed direction changes each time,

$$Δ t = \frac{1}{{k}_{max} * n} .$$

In the mentioned scheme, said laser terminal output module makes uniform speed and horizontal reciprocating motion along the axis of the cylinder to be processed. By using the position sensor or grating ruler, the displacement Δxₜ of the laser head in the circumferential direction relative to the initial processing point x is monitored in real time, and the position of the laser head is adjusted timely compared with the instantaneous rotation angle βₜ of the coaxial encoder 2, βₜ ∈ [0,2π] to ensure

$$\frac{{β}_{t} d / 2}{Δ {x}_{t}} = tan θ .$$

Said examples are preferred embodiments of the present invention, but the invention is not limited to the aforesaid embodiments. Without deviating from the substance of the invention, any obvious improvements, substitutions and variations that can be made by the person skilled in the art fall within the protection scope of the present invention.

1. A roller laser texturing processing method, characterized in that, it comprises the following steps:
dividing processing zones: the processing zone on the surface of roller is evenly divided into several roller processing units;
determining the scheme of distribution: according to the mentioned roller processing unit parameters and morphological parameters, the distribution scheme of end-to-end, unordered and uniformly distributed texturing lattice is obtained by the design method of end-to-end, unordered and uniformly distributed lattice;
determining the output signal: on the basis of the mentioned distribution scheme of end-to-end, unordered and uniformly distributed texturing lattice, the machine tool parameters and laser parameters, the laser output position signal, beam energy regulation signal and deflection signal of one-dimensional beam deflection unit are obtained through the information processing module;
laser texturing processing of roller: said laser output position signal is used for controlling the light source module to emit laser; said beam energy regulation signal and deflection signal of one-dimensional beam deflection unit are input into the laser terminal output module, respectively, to generate the unordered laser lattice, each laser terminal output module is used for processing one roller processing unit.

2. Implementing the method for roller laser texturing processing said in claim 1, characterized in that division of the processing zone includes specifically:
Determining the roller surface processing zone; said roller processing zone being a square area with length L₀₁ and width πd, wherein, L₀₁=5%˜100%L₀₋₀₁ is the distance from the end face of roller, L₀₋₀₁=0˜90%L₀; L₀ is the developed length of the roller surface, and d is the diameter of the roller;
the processing zone of roller is evenly divided into m roller processing units, and the length of any roller processing unit is L₁,
$${L}_{1} = \frac{1}{{m}_{max}} {L}_{0 \; 1} ;$$
the width or any roller processing unit is πd; wherein, m ∈ {1,2,3. . . mₘₐₓ}, mₘₐₓ=1˜30.

3. Implementing the method for roller laser texturing processing said in claim 1, characterized in that the laser terminal output module includes beam back-turning unit 6, beam energy regulation unit 5 and one-dimensional beam deflection unit 4; the incident laser from said light source module passes successively through the beam back-turning unit 6, beam energy regulation unit 5 and one-dimensional beam deflection unit 4, and then into the roller processing unit;
said beam back-turning unit 6 is used to split the incident laser from the light source module into a reflected laser perpendicular to the axis direction of the roller and a transmitted laser parallel to the axis direction of the roller; said reflected laser enters into the beam energy regulating unit 5, and said transmitted laser enters into the next laser terminal output module;
said beam energy regulating unit 5 is used to change the energy of said reflected laser;
said one-dimensional beam deflection unit 4 is used to offset the angle of said reflected laser.

4. Implementing the method for roller laser texturing processing said in claim 3, characterized in that based on the different coating properties of each semi-reflective lens, the beam back-turning unit 6 makes the energy ratio of reflected laser and transmitted laser as:
$$\frac{{P}_{m}}{{P}_{m -}} = 1 \text{:} ( {m}_{max} - m ) \text{;} {P}_{m} = {P}_{output} = \frac{1}{{m}_{max}} {P}_{input} , \\ m = 1 , 2 , 3 … {m}_{max} ;$$
wherein Pₘ is the power of reflected laser split by the beam back-turning unit 6 in the Lineₘ-th laser terminal output module;
Pₘ—is the power of transmitted laser split by the beam back-turning unit 6 in the Lineₘ-th laser terminal output module;
Pᵢₙₚᵤₜ is the power of laser source output by the laser source module;
Pₒᵤₜₚᵤₜ is the laser power input by the laser terminal output module.
said beam energy regulating unit 5 attenuates the beam energy at a fixed value based on the input electrical signal ψ, that is P_{focus}=(1-Damp(ψ) Pₒᵤₜₚᵤₜ, wherein ψ is the input electric signal of the driving power supply of the beam energy regulating unit 5, ψ ∈ [ψₘᵢₙ, ψₘₐₓ], the corresponding energy attenuation ratio Damp(ψ) varies from 0 to 100%, ψₘᵢₙ is the minimum input electrical signal; ψₘₐₓ is the maximum input electrical signal; Damp (ψ) is the laser energy attenuation ratio; P_{focus} is the laser power output by said beam energy regulating unit;
said one-dimensional beam deflection unit 4 makes the beam deflect in one-dimension at a fixed angle α according to the input electrical signal ξ, then the beam passes through the focus lens and acts on the area to be processed, so as to make focal point offset a determined distance σ relative to the optical axis,
σ=f(α,L₂, f)=f(α(ξ),L₂,f),
σₘᵢₙ=f(αₘᵢₙ, L₂, f)=f(0L₂, f)
σₘₐₓ=f(η*αₘₐₓ, L₂, f)
wherein, L₂ is the distance between said one-dimensional beam deflection unit 4 and the surface of the workpiece; f is the focal length when said one-dimensional beam deflection unit 4 does not deflect; α is the deflection angle of beam caused by the one-dimensional beam deflecting unit 4, that is α=α(ξ); αₘᵢₙ is the minimum deflection angle of beam caused by the one-dimensional beam deflecting unit 4; αₘₐₓ is the maximum deflection angle of beam caused by the one-dimensional beam deflecting unit 4; η is the safety service factor of one-dimensional beam deflection unit 4; σ is the offset of focal position; σₘᵢₙ is the minimum offset of focal position; σₘₐₓ is the maximum offset of focal position.

5. Implementing the method for roller laser texturing processing said in claim 1, characterized in that said design method of the end-to-end, unordered and uniform lattice distribution includes the following steps:
according to the distribution of morphology parameters, the circle center set A₀ of texturing points of uniform lattice distribution is established, which is as follows specifically:
$${A}_{0} = \{ ( {x}_{0 i} , {y}_{0 j} ) \vert \begin{matrix}{x}_{0 i} = a ( j - 1 ) , & {y}_{0 j} = b ( i - 1 ) , \\ i = 1 , 2 , 3 … {i}_{max} , & j = 1 , 2 , 3 … {j}_{max}\end{matrix} \}$$
wherein, A₀ is the set of circle center coordinates of texturing points of uniform lattice distribution; (x₀ᵢ, y₀ⱼ) is the circle center coordinate of texturing point of uniform lattice distribution in row i and column j; i represents the row serial number; iₘₐₓ is the maximum row serial number; iₘₐₓ=πd/b; j represents the column serial number; jₘₐₓ=[L₁/α]+1; jₘₐₓ is the maximum column serial number; a is the morphologic distribution dot spacing, which is the distance between two texturing hard points in the x direction; b is morphologic distribution line spacing, which is the distance between two texturing hard points in they direction;
the set ΔX of random displacement vectors for each texturing point in uniform lattice distribution is established, which is as follows specifically:
$$Δ X = \{ ( δ {x}_{i} , δ {y}_{j} ) \vert \begin{matrix}δ {x}_{i} = rand ( - 1 , 1 ) * {ɛ}_{b} , \\ δ {y}_{j} = rand ( - 1 , 1 ) * {ɛ}_{a} , \\ i = 1 , 2 , 3 … {i}_{max} , j = 1 , 2 , 3 … {j}_{max}\end{matrix} \}$$
wherein, ΔX is the set of random displacement vectors for each texturing point in uniform lattice distribution; (δxᵢ, δyⱼ) is the random displacement vector of the circle center coordinate(x₀ᵢ, y₀ⱼ) of the texturing points of uniform lattice distribution in row i and column j in the uniform lattice distribution; εₐ is the constant of column offset; ε_{b} is the constant of row offset;
establishing the circle center set A of texturing points of unordered and uniform distribution: add the set A ₀ of circle center coordinates of texturing points of uniform lattice distribution to the set ΔX of random displacement vectors for each texturing point in uniform lattice distribution, as follows:
$$A = {A}_{0} + Δ X = \{ ( {x}_{i} {y}_{i} ) \vert \begin{matrix}( {x}_{i} , {y}_{i} ) = ( δ {x}_{0 i} , δ {y}_{0 j} ) + ( δ {x}_{i} , δ {y}_{j} ) , \\ i = 1 , 2 , 3 … {i}_{max} , j = 1 , 2 , 3 … {j}_{max}\end{matrix} \}$$
wherein, A is the circle center set of texturing points of unordered and uniform distribution; (xᵢ, yⱼ) is the circle center coordinates of texturing points of unordered and uniform distribution;
finding the bad points: find the set SP of row and column sequences of the bad points of unordered and uniform distribution according to the tolerance to overlap of texturing points, as follows specifically:
$$SP = \{ ( {u}_{q} , {w}_{q} ) \vert \begin{matrix}( {u}_{q} , {w}_{q} ) = ( i , j ) , \\ \vert A ( i , j ) - A ( i + 1 , j ) \vert < ζ * D or \\ \vert A ( i , j ) - A ( i , j + 1 ) \vert < ζ * D or \\ \vert A ( i , j ) - A ( i + 1 , j + 1 ) \vert < ζ * D , \\ i = 2 , 3 , 4 … {i}_{max} - 1 , \\ j = 2 , 3 , 4 … {j}_{max} - 1 , \\ q = 1 , 2 , 3 … \end{matrix} \}$$
wherein, SP is the set of row and column sequences of the bad points of unordered and uniform distribution; A(i,j) is the circle center coordinate of texturing points in row i and column j in the set of the center coordinates of texturing points of unordered and uniform distribution in row i and column j; (u_{q}, w_{q}) is the coordinate row and column sequences of the q-th bad point; q is the sequence number of bad point; ζ is an overlap tolerance constant of texturing points of unordered and uniform distribution;
estimating whether there is a bad point: there are bad points when SP≠Ø, then the random displacement vector set ΔX is adjusted according to the bad points set SP of unordered and uniform distribution, and the steps of establishing the circle center set A of texturing points of unordered and uniform distribution and finding the bad points are repeated until SP=Ø; while SP=Ø, there are no bad points;
establishing the circle center set Aex of texturing points of unordered and uniform distribution by left-right exchange of the circle center set A of texturing points of unordered and uniform distribution with reference to the axial center line: when SP=Ø the circle center set A of texturing points of unordered and uniform distribution is subjected to left-right exchange with reference to the axial center line, so that the lap joint of the processing areas of a number of laser terminal output modules can be achieved:
$$Aex = \{ ( {xex}_{i} , {yex}_{j} ) \vert \begin{matrix}( {xex}_{i} , {yex}_{j} ) \{ \begin{matrix}( {x}_{i} + \frac{1}{2} {L}_{1} , {y}_{j} ) , & {x}_{i} < \frac{1}{2} {L}_{1} \\ ( {x}_{i} - \frac{1}{2} {L}_{1} , {y}_{j} ) , & {x}_{i} \geq \frac{1}{2} {L}_{1}\end{matrix} , \\ ( {x}_{i} , {y}_{j} ) ∈ A , \\ i = 1 , 2 , 3 … {i}_{max} , j = 1 , 2 , 3 … {j}_{max}\end{matrix} \}$$
wherein, Aex is the circle center set of texturing points of unordered and uniform distribution which is obtained through left-right exchange of the circle center set A of texturing points of unordered and uniform distribution with reference to the axial center line; (xexᵢ, yexⱼ) refers to the circle center coordinates of texturing points in row i and column j after left-right exchange;
finding the bad points in the area near the center line: in the area near the center line after the process of left-right exchange, find the set SPex of row and column sequences of the bad points of unordered and uniform distribution according to the tolerance to overlap of texturing points, as follows specifically:
$$SPex = \{ ( {uex}_{qex ,} {wex}_{qex} ) \vert \begin{matrix}( {uex}_{qex} , {wex}_{qex} ) = ( i , j ) , \\ \vert Aex ( i , j ) - Aex ( i + 1 , j ) \vert < ζ * D or \\ \vert Aex ( i , j ) - Aex ( i , j + 1 ) \vert < ζ * D or \\ \vert Aex ( i , j ) - Aex ( i + 1 , j + 1 ) \vert < ζ * D , \\ Aex ( i , j ) ∈ Center , \\ i = 1 , 2 , 3 … {i}_{max} , \\ j = 1 , 2 , 3 … {j}_{max} , \\ qex = 1 , 2 , 3 … \end{matrix} \}$$
wherein, SPex is the set of row and column sequences of the bad points of unordered and uniform distribution found in the area near the center line after the process of left-right exchange according to the tolerance to overlap of texturing points; (uex_{qex}, wex_{qex}) is the row and column sequences of coordinate of the qex-th bad point; qex is the sequence number of bad point; Aex(i,j) is the circle center coordinates of texturing point in row i and column j in the set of the circle center coordinates of texturing points of unordered and uniform distribution after exchange; Center is the area near the center line after the process of left-right exchange:
$$Center = \{ ( x , y ) \vert x ∈ [ ( 1 - \frac{ϖ}{2} ) \frac{{L}_{1}}{2} , ( 1 + \frac{ϖ}{2} ) \frac{{L}_{1}}{2} ] , y ∈ [ 0 , π d ] \}$$
where ω̅ is the proportion of the area near the input center line;
estimating whether there is a bad point in the area near the center line: there are bad points when SPex≠Ø, then the position of bad points in the area near the centerline is adjusted according to the bad points set SPex of unordered and uniform distribution in the area near the centerline, and the steps of establishing the circle center set Aex of texturing points of unordered and uniform distribution by left-right exchange of the circle center set A of texturing points of unordered and uniform distribution with reference to the axial center line and finding the bad points in the area near the center line are repeated until SPex=Ø;
while SPex=Ø, there are no bad points, that is, Aex is the mentioned distribution scheme of end-to-end, unordered and uniformly distributed texturing lattice.

6. Implementing the method for roller laser texturing processing said in claim 5, characterized in that the random displacement vector set ΔX is adjusted according to the bad points set SP of unordered and uniform distribution, as follows specifically:
$$Δ X = \{ ( δ {x}_{i} , δ {y}_{j} ) \vert \begin{matrix}( δ {x}_{i} , δ {y}_{j} ) = ( δ {xre}_{i} , δ {yre}_{j} ) , \\ ( δ {xre}_{i} , δ {yre}_{j} ) ∈ Δ Xre , \\ i = 1 , 2 , 3 … {i}_{max} , j = 1 , 2 , 3 … {j}_{max} ,\end{matrix} \}$$
$$where Δ Xre = \{ ( δ {xre}_{i} , δ {yre}_{j} ) \vert \begin{matrix}( δ {xre}_{i} , δ {yre}_{j} ) = \{ \begin{matrix}λ ( δ {x}_{i} , δ {y}_{j} ) , & ( i , j ) ∈ SP \\ ( δ {x}_{i} , δ {y}_{j} ) , & ( i , j ) ∉ SP\end{matrix} , \\ i = 1 , 2 , 3 … {i}_{max} , j = 1 , 2 , 3 … {j}_{max} , \\ ( δ {x}_{i} , δ {y}_{j} ) ∈ Δ X\end{matrix} \}$$
wherein, ΔXre is the adjusted set of random displacement vectors; (δxreᵢ, δyre ⱼ) is the adjusted random displacement vector; λ is the adjustment ratio of random displacement vector for a bad point;
the position of bad points in the area near the centerline is adjusted according to the mentioned bad points set SPex of unordered and uniform distribution in the area near the centerline, as follows specifically:
$$Aex = \{ ( {xex}_{i} , {yex}_{j} ) \vert \begin{matrix}( {xex}_{i} , {yex}_{j} ) = ( {xre}_{i} , {yre}_{j} ) , \\ ( {xre}_{i} , {yre}_{j} ) ∈ Are , \\ i = 1 , 2 , 3 … {i}_{max} , j = 1 , 2 , 3 … {j}_{max}\end{matrix} \}$$
$$where Are = \{ ( {xre}_{i} , {yre}_{j} ) \vert \begin{matrix}( {xre}_{i} , {yre}_{j} ) = \\ \{ \begin{matrix}( {xex}_{i} , {yex}_{j} ) - ϑ ( δ {x}_{i} , δ {y}_{j} ) , ( i , j ) ∈ SPex \\ ( {xex}_{i} , {yex}_{j} ) , ( i , j ) ∉ SPex\end{matrix} , \\ i = 1 , 2 , 3 … {i}_{max} , j = 1 , 2 , 3 … {j}_{max} , \\ ( {xex}_{i} , {yex}_{j} ) ∈ Aex , \\ ( δ {x}_{i} , δ {y}_{j} ) ∈ Δ X\end{matrix} \}$$
wherein, Are is the set of the circle center coordinates of texturing points of unordered and uniform distribution after adjusting the positions of bad points in the area near the centerline; (xreᵢ, yreⱼ) is the circle center coordinate of a texturing point in row i and column j in the set of the circle center coordinates of texturing points of unordered and uniform distribution after adjusting the positions of bad points in the area near the centerline; ϑ is the adjustment ratio of coordinates of bad points in the area near the centerline.

7. Implementing the method for roller laser texturing processing said in claim 4, characterized in that the laser output position signal, beam energy regulation signal and deflection signal of one-dimensional beam deflection unit are obtained through the information processing module, as follows specifically:
calculating the angle between the motion track of focal point and the axial direction of roller: when the one-dimensional beam deflection unit 4 is not working, that is α=0, the angle θ between the motion track of focal point and the axial direction of roller is:
$$θ = {tan}^{- 1} \frac{π * n * d}{υ}$$
where n is rotating speed of the roller; v is the running speed of the laser terminal output module;
determining the set K of focal point motion track sequence number and calculating the set P of the number of turns of each focal point motion track moving around the metal cylinder,
$$k ∈ K = \{ 1 , 2 , 3 , … {k}_{max} \} , \\ where {k}_{max} = \{ \begin{matrix}\frac{π d}{{σ}_{max} tan θ} , & \frac{π d}{{σ}_{max} tan θ} is an integer \\ ⌊ \frac{π d}{{σ}_{max} tan θ} ⌋ + 1 , & \frac{π d}{{σ}_{max} tan θ} is not an integer\end{matrix} ; \\ p ∈ P = \{ 1 , 2 , 3 … {p}_{max} \} , \\ where {p}_{max} = \{ \begin{matrix}\frac{{L}_{1}}{π d cot θ} , & \frac{{L}_{1}}{π d cot θ} is an integer \\ ⌊ \frac{{L}_{1}}{π d cot θ} ⌋ + 1 , & \frac{{L}_{1}}{π d cot θ} is not an integer\end{matrix} ;$$
wherein, K is the set of focal point motion track sequence number; k is the k-th focal point motion track, that is, the k-th processing process; P is the set of the number of turns of each focal point motion track moving around the metal cylinder; p is the p-th turn of focal point motion track moving around the metal cylinder;
when the deflection angle α of the one-dimensional beam deflection unit 4 is α ∈ [0, η* αₘₐₓ], the set Λ of focal point coverage Λₖ of laser terminal output module during the k-th processing process is determined, as follows specifically:
$$Λ = \{ {Λ}_{k} \vert {Λ}_{k} = \{ ( x , y ) \vert \begin{matrix}\begin{matrix}x ∈ [ {xk}_{min} ( y , p = 1 ) , \\ {xk}_{max} ( y , p = 1 ) ) ⋃\end{matrix} \\ \begin{matrix}[ {xk}_{min} ( y , p = 2 ) , \\ {xk}_{max} ( y , p = 2 ) ) ⋃\end{matrix} \\ \begin{matrix}[ {xk}_{min} ( y , p = 3 ) , \\ {xk}_{max} ( y , p = 3 ) ) ⋃\end{matrix} \\ … ⋃ \\ \begin{matrix}[ {xk}_{min} ( y , p = {p}_{max} ) , \\ {xk}_{, max} ( y , p = {p}_{max} ) ) ,\end{matrix} \\ y ∈ [ 0 , π d )\end{matrix} \} , k = 1 , 2 , 3 … {k}_{max} \} , \\ where$$
$${xk}_{min} ( y , p ) = xk ( y , p , σ = 0 ) = \frac{[ y - \frac{π d}{{k}_{max}} k ]}{tan θ} + \frac{π d}{tan θ} ( p - 1 ) , \\ y ∈ [ 0 , π d ) , \\ p ∈ P , \\ k ∈ K , \\ {xk}_{max} ( y , p ) = xk ( y , p , σ = {σ}_{max} ) = \frac{[ y - \frac{π d}{{k}_{max}} ( k - 1 ) ]}{tan θ} + \frac{π d}{tan θ} ( p - 1 ) , \\ y ∈ [ 0 , π d ) , \\ p ∈ P , \\ k ∈ K ,$$
where Λ is the set of focal point coverage of laser terminal output module during each processing process; Λₖ is the focal point coverage of laser terminal output module during the k-th processing process; xkₘᵢₙ(y,p)=xk(y, p, σ=0) is the equation of the p-th turn of the k-th focal point motion track, when the deflection angle α=0, that is, deflection offset σ=0; xkₘₐₓ(y, _{P})=xk(y, p, σ=σₘₐₓ) is the equation of the p-th turn of the k-th focal point motion track, when the deflection angle α=η* αₘₐₓ, that is, deflection offset σ=σₘₐₓ;
the set Φ of the circle center coordinates of unordered and uniform texturing points in the focal point coverage of laser terminal output module during each processing process is counted, as follows specifically:
$$Φ = \{ {Φ}_{k} \vert k = 1 , 2 , 3 … {k}_{max} \} , \\ where {Φ}_{k} = \{ ( {x}_{rk} , {y}_{rk} ) \vert \begin{matrix}( {x}_{rk} , {y}_{rk} ) = ( {xex}_{i} , {yex}_{j} ) , \\ ( {xex}_{i} , {yex}_{j} ) {ϵΛ}_{k} , ( {xex}_{i} , {yex}_{j} ) ∈ Aex , \\ i = 1 , 2 , 3 … {i}_{max} , j = 1 , 2 , 3 … {j}_{max} , \\ rk = 1 , 2 , 3 … \end{matrix} \} , \\ k ∈ K ,$$
wherein, Φ is the set of the circle center coordinates of unordered and uniform texturing points in the focal point coverage of laser terminal output module during each processing process; Φₖ is the circle center coordinates of unordered and uniform texturing points in the focal point coverage Λₖ of laser terminal output module during the k-th processing process, that is, the circle center coordinates fall into the set of the circle center coordinates of texturing points between the two trajectories xkₘᵢₙ=xk(y, σ=0) and xkₘₐₓ=xk(y, σ32 σₘₐₓ); (x ᵣₖ, yᵣₖ) is the circle center coordinate of the rk-th unordered and uniform texturing point included during the k-th processing process; rk is the statistical sequence of unordered and uniform texturing points included in the k-th processing process;
determining the set Ωₖ of circle center coordinates of the texturing points after sorting in the k-th processing process. (xᵣₖ, yᵣₖ) is sorted according to the processing sequence of the texturing points to obtain the set Ωₖ of circle center coordinates of the texturing points after sorting. The specific sorting rules are as follows:
$${Ω}_{k} = \{ ( {x}_{τ k} , {y}_{τ k} ) \vert τ k = 1 , 2 , 3 … {rk}_{max} \} = \{ \begin{matrix}\{ \begin{matrix}( {x}_{rk} , {( {y}_{rk} )}_{min} ) , \\ … , \\ ( {x}_{rk} , {( {y}_{rk} )}_{max} )\end{matrix} \vert \begin{matrix}( {x}_{rk} , {y}_{rk} ) ∈ {Φ}_{k} , \\ rk = 1 , 2 , 3 … {rk}_{max} , \\ k is odd\end{matrix} \} \\ \{ \begin{matrix}( {x}_{rk} , {( {y}_{rk} )}_{max} ) , \\ … , \\ ( {x}_{rk} , {( {y}_{rk} )}_{min} )\end{matrix} \vert \begin{matrix}( {x}_{rk} , {y}_{rk} ) ∈ {Φ}_{k} , \\ rk = 1 , 2 , 3 … {rk}_{max} , \\ k is even\end{matrix} \}\end{matrix} , \\ k ∈ K$$
wherein, Ωₖ is the set of circle center coordinates formed by sorting the circle center coordinates of unordered and uniform texturing points in the focal point coverage Λₖ during the k-th processing process according to the processing sequence of the texturing points; (x_{τk}, y_{τk}) is the coordinate of the τk-th processing texturing point in the k-th processing process; τk is the processing sequence number of the texturing points in the k-th processing process; τkₘₐₓ is the maximum statistical value of the number of unordered and uniform texturing points included in the focal point coverage Λₖ during the k-th processing process; (yᵣₖ)ₘₐₓ is the maximum value of y-axis coordinates of the circle center coordinates (xᵣₖ, yᵣₖ) of unordered and uniform texturing points in the focal point coverage Λₖ during the k-th processing process; (yᵣₖ)ₘᵢₙ is the minimum value of y-axis coordinates of the circle center coordinates (xᵣₖ, yᵣₖ) of unordered and uniform texturing points in the focal point coverage Λₖ during the k-th processing process;
finding the set MSPₖ of processing singular points in Ωₖ: search the set MSPₖ of processing singular points in Ωₖ according to the response frequency of the processing system. The specific searching method is as follows:
$${MSP}_{k} = \{ {msp}_{mk} \vert \begin{matrix}{msp}_{mk} = τ k , \\ \frac{\vert {y}_{τ k} - {y}_{τ k - 1} \vert}{π * n * d} < \frac{1}{F} or \frac{\vert {y}_{τ k} - {y}_{τ k - 1} \vert}{π * n * d} < \frac{1}{F} , \\ ( {x}_{τ k} , {y}_{τ k} ) ∈ {Ω}_{k} , \\ τ k = 2 , 3 , 4 … {rk}_{max} - 1 , \\ mk = 1 , 2 , 3 … \end{matrix} \} , \\ k ∈ K , \\ where F = \frac{1}{ϱ} * min ( Maxf {Las}_{mor} , Maxf {P}_{res} , Maxf {EX}_{res} , \frac{n}{{R}_{encoder}} )$$
wherein, MSPₖ is the set of the processing singular points in Ωₖ; mspₘₖ is the processing sequence number of the processing singular points in the k-th processing process; F is the comprehensive response frequency of the processing system; MaxfLasₘₒᵣ is the maximum output frequency of output laser for processing the mor-th morphology; MaxfPᵣₑₛ is the highest response frequency of the beam energy regulation unit; MaxfEXᵣₑₛ is the highest response frequency of the one-dimensional beam deflection unit 5; R_{encoder} is the resolution of the encoder 2 rotationally and coaxially mounted with the roller; [symbol] is the safety factor of the response frequency of the system;
estimating whether there is a processing singular point: when MSPₖ≠Ø, and k ∈ K, then there is a processing singular point, the set Ωₖ of the circle center coordinates of unordered and uniform texturing points which are arranged according to the processing sequence in the focal point coverage Λₖ during the k-th processing process is adjusted according to the set MSPₖ of the processing singular points in Ωₖ; the steps of determining set Ωₖ of circle center coordinates of the texturing points after sorting in the k-th processing process and finding the set MSPₖ of processing singular points in Ωₖ are repeated until MSPₖ=Ø, While SP=Ø, there is no bad point;
when MSPₖ=Ø, and k ∈ K, calculating the set ΓLineₘ of signal set of laser output position signal-the beam energy regulation signal-deflection signal of one-dimensional beam deflection unit of the laser terminal output module:
$$Γ {Line}_{m} = \{ Γ {Line}_{{m}_{k}} , k = 1 , 2 , 3 … {k}_{max} \} , \\ m ∈ \{ 1 , 2 , 3 … {m}_{max} \} , \\ where$$
$$Γ {Line}_{{m}_{k}} = \{ ( {β}_{τ k} , ψ {m}_{τ k} , {ξ}_{τ k} ) \vert \begin{matrix}{β}_{τ k} = 2 π \frac{{y}_{τ k}}{π d} , \\ ψ {m}_{τ k} = rand ( {ψ}_{min} , ς * {ψ}_{max} ) or \\ ψ {m}_{τ k} = {ψ}_{min} , \\ \{ \begin{matrix}{σ}_{τ k} = {x}_{τ k} - {xk}_{min} ( y = {y}_{τ k} , p = {p}_{τ k} ) \\ {p}_{τ k} = ⌈ \frac{{x}_{τ k} - {xk}_{min} ( y = {y}_{τ k} , p = 1 )}{π d cot θ} ⌉ , \\ {σ}_{τ k} = f ( {α}_{τ k} ) = f ( α ( {ξ}_{τ k} ) )\end{matrix} \\ ( {x}_{τ k} , {y}_{τ k} ) ∈ {Ω}_{k} , τ k = 1 , 2 , 3 … {r}_{max}\end{matrix} \} , \\ k ϵ K , \\ m ∈ \{ 1 , 2 , 3 … {m}_{max} \} ,$$
wherein, ΓLineₘ is the set of the signal set of laser output position signal-the beam energy regulation signal-deflection signal of one-dimensional beam deflection unit of the m-th laser terminal output module during each processing process; ΓLineₘ_{ₖ} is the signal set of laser output position signal-the beam energy regulation signal-deflection signal of one-dimensional beam deflection unit needed by the m-th laser terminal output module for unordered and uniform texturing points which are arranged according to the sequence of processing in the focal point coverage during the k-th processing process; (β_{τk}, ψm_{τk}, ξ_{τk}) is the same laser output position signal, the beam energy regulation signal of the m-th laser terminal output module, and the same deflection signal of one-dimensional beam deflection unit sent to the processing system during processing of the τk-th texturing point in the k-th processing process; p_{τk} is the number of turns for processing the rk-th texturing point during the k-th processing process; ζ is the maximum attenuation ratio constant of laser energy of the beam energy regulation unit 5.

8. Implementing the method for roller laser texturing processing said in claim 7, characterized in that the set Ωₖ of the circle center coordinates of unordered and uniform texturing points which are arranged according to the sequence of processing in the focal point coverage Λₖ during the k-th processing process is adjusted according to the set MSPₖ of the processing singular points in Ωₖ, as follows specifically:
$${Ω}_{k} = \{ ( {x}_{τ k} , {y}_{τ k} ) \vert \begin{matrix}( {x}_{τ k} , {y}_{τ k} ) = ( {xre}_{τ k} , {yre}_{τ k} ) , \\ ( {xre}_{τ k} , {yre}_{τ k} ∈ Ω {re}_{k} \\ τ k = 2 , 3 , 4 … {rk}_{max}\end{matrix} \} , \\ k ∈ K$$
$$where Ω {re}_{k} = \{ ( {xre}_{τ k} , {yre}_{τ k} ) \vert \begin{matrix}( {xre}_{τ k} , {yre}_{τ k} ) \\ \{ \begin{matrix}\{ \begin{matrix}( {x}_{τ k} , {y}_{τ k} - {Δ}_{τ k} ) , k is odd \\ ( {x}_{τ k} , {y}_{τ k} + {Δ}_{τ k} ) , k is even\end{matrix} , \\ τ k ∈ {MSP}_{k} \\ ( {x}_{τ k} , {y}_{τ k} ) , τ k ∉ {MSP}_{k}\end{matrix} , \\ ( {x}_{τ k} , {y}_{τ k} ) ∈ {Ω}_{k} , \\ {Δ}_{τ k} = γ * \vert {y}_{τ k} - {y}_{τ k - 1} \vert , \\ τ k = 2 , 3 , 4 … {rk}_{max}\end{matrix} \} , \\ k ∈ K$$
wherein, Ωreₖ is the adjusted set of the circle center coordinates of unordered and uniform texturing points which are arranged according to the sequence of processing in the focal point coverage Λₖ during the k-th processing process; (xre_{τk}, yre_{τk}) is the adjusted circle center coordinate of the τk-th texturing point processed during the k-th processing process; Δ_{τk} is the adjustment amount of y-axis of the circle center coordinate of the τk-th texturing point processed during the k-th processing process; γ is the adjustment ratio of the adjustment amount of y-axis coordinate.

9. Implementing the method for roller laser texturing processing said in claim 5, characterized in that the method for determining the morphologic distribution dot spacing a and the morphologic distribution line spacing b is as follows:
determining the type of morphology of laser texturing hard points;
according to the initial value ρ0 of area occupancy, calculating the initial value α0 of the morphologic dot spacing and the initial value b0 of morphologic line spacing, as follows specifically:
$$a 0 = b 0 = \sqrt{\frac{{π ( {D}_{mor} / 2 )}^{2}}{ρ 0}}$$
wherein, ρ0 is the preset initial value of the morphological area occupancy; α0 is the initial value of the morphologic distribution dot spacing, which is the initial value of the distance between two texturing hard points in the x direction; b0 is the initial value of the morphologic distribution line spacing, which is the initial value of the distance between two texturing hard points in the y direction; Dₘₒᵣ is the diameter of the mor-th morphology;
correcting morphologic distribution dot spacing, morphologic distribution line spacing and area occupancy, as follows specifically:
$$a = b = \frac{π d}{⌊ π d / b 0 ⌋} , \\ ρ = \frac{{π ( {D}_{mor} / 2 )}^{2}}{a * b} ,$$
wherein, ρ is the area occupancy of morphology; α is the morphologic distribution dot spacing, which is the distance between two texturing hard points in the x direction; b is the morphologic distribution line spacing, which is the distance between two texturing hard points in they direction.

10. The processing equipment for implementing the roller laser texturing processing method in claim 1, characterized in that it comprises a computer, a light source module and a laser terminal output module; said computer comprises a design module for end-to-end, unordered and uniform lattice distribution and a signal processing module; according to the roller processing unit parameters and morphological parameters, the distribution scheme of end-to-end, unordered and uniform texturing lattice is obtained by the design module for end-to-end, unordered and uniform lattice distribution; according to said scheme of end-to-end, unordered and uniform texturing lattice distribution, the machine tool parameters and laser parameters, the laser output position signal, beam energy regulation signal and deflection signal of one-dimensional beam deflection unit are obtained through the information processing module;
said laser output position signal is used to control the light source module to emit the laser;
said beam energy regulation signal and deflection signal of one-dimensional beam deflection unit are input into the laser terminal output module, respectively, to generate an unordered laser lattice, each laser terminal output module is used to process a roller processing unit;
each of the laser terminal output module reciprocates axially in the corresponding roller processing unit area, the initial line of said reciprocating motion is
$$x = - \frac{π d}{{k}_{max}} cot θ$$
and the termination line is x=L₁.
